(19) United States
(12) Patent Application Publication
(10) Pub. No.: US 2018/0188018 A1
(43) Pub. Date: Jul. 5, 2018

(54) LIGHT FIXTURES, SYSTEMS, AND METHODS FOR OPERATING AND/OR CONTROLLING LIGHT FIXTURES

(71) Applicant: Flow Lighting, LLC, South Lake, TX (US)

(72) Inventors: Gregory A. M. BROWN, Reno, NV (US); Greg PHILLIPS, Reno, NV (US); Richard HICKSTED, Reno, NV (US)

(73) Assignee: Flow Lighting, LLC, South Lake, TX (US)

(21) Appl. No.: 15/738,850

(22) PCT Filed: Jun. 27, 2016
(86) PCT No.: PCT/US16/39584

§ 371 Date: Dec. 21, 2017

Related U.S. Application Data
(60) Provisional application No. 62/185,621, filed on Jun. 27, 2015.
(60) Provisional application No. 62/277,079, filed on Jan. 11, 2016.

(51) Int. Cl. G01B 11/14; H05B 33/08; H05B 37/02; G01C 3/08

(52) U.S. Cl. CPC G01B 11/14; H05B 33/0842; F21S 9/022; H05B 37/0218; G01C 3/08; H05B 37/0227

(57) ABSTRACT

This disclosure includes light fixtures, systems and/or kits including light fixtures. This disclosure also includes controls, control systems, and methods of controlling devices such as light fixtures.

### CROSS-REFERENCE TO RELATED APPLICATIONS

This application claims the benefit of U.S. Provisional Patent Application No. 62/185,621, filed Jun. 27, 2015 and U.S. Provisional Patent Application No. 62/277,079, filed Jan. 11, 2016. The contents of the referenced applications are incorporated into the present application by reference.

### BACKGROUND

### 1. Field of Invention

The present invention is generally related to light fixtures and more particularly, but not by way of limitation, to retrofit and new light fixtures (e.g., light-emitting-diode (LED) light fixtures) for replacement of traditional fluorescent light fixtures.

### 2. Description of Related Art

There are billions of fluorescent light fixtures throughout the U.S. and the world. Most energy costs for lighting are generated in office and commercial space, which primarily utilize fluorescent light fixtures. It is estimated that commercial lighting demand consumes up to 25% of the total energy consumed in the U.S. alone. In addition, the Department of Energy (DOE) estimated in 2010 that linear fluorescent lighting represents the overall highest electricity consumer at 42 percent of energy used for lighting. With almost 15 billion square feet of office space in the U.S. alone this market is enormous. The DOE 2010 U.S. Lighting Market Characterization report estimates that 81.2 billion square feet in Commercial Building space that contains over 2.1 billion light fixtures in commercial buildings with 71.8% of commercial fixtures being linear fluorescent fixtures. This translates to more than 1.5 billion linear fluorescent fixtures in the U.S. in commercial buildings alone.

The commercial light fixture market has been predominantly standardized to 2×4 (2 foot×4 foot) recessed fixtures, which are typically installed in suspended grid ceiling systems. In addition to the overwhelming number of 2×4 fixtures there are also 2×2 and 1×4 fixtures and while most are recessed (or mounted on suspended grid ceiling systems)—some are surface mounted fixtures and still fewer are mounted in other ways. The change from fluorescent to LED that has already started is tantamount to when fluorescent lighting replaced incandescent lighting in commercial and industrial spaces.

Fluorescent fixtures have improved over the years for better efficiency and reduced energy consumption through the use of better ballasts and lamping modifications (T12, T8, T5, etc.). In addition various lens modifications have been designed over the years to reduce glare or improve light distribution, but they did not typically provide notable energy savings. Some fixtures and lamp types can be retrofitted with a dimming ballast—a key feature in reduction of energy consumption, however most fluorescent fixtures cannot be made dimmable. In more recent years dimming ballasts have been added to some fluorescent lamped fixtures—the most common commercial lamps deployed. However, these dimming ballasts are both expensive to purchase and install and they can dramatically reduce lamp life and ballast life, which increases the life cycle cost of the fixtures offsetting energy savings and reducing the incentive to upgrade the fixtures. The upgrades and modifications to fluorescent fixtures, lamps, ballasts and other components have largely been incentivized over the years with rebates, tax credits and other incentives which have covered much if not all of the costs for improvements to these fixtures to promote energy reduction. Likewise, numerous grants, rebates, and tax credits and other incentives are available to implement a retrofit from fluorescent to LED systems.

Commercial light fixtures typically function in banks or zones of lights within an office or commercial space and large numbers of lights may be ganged or interconnected and wired to one switch to reduce the number of switches, costs and complexity. Therefore, these light fixtures cannot be controlled individually or even effectively in smaller groups. A light switch or control system will govern specific banks of light fixtures or zones within an occupied space and these zones are highly inefficient in the use of energy for lighting since the controls apply to so many fixtures and lack flexibility. For example, an entire zone or bank of light fixtures on a given floor may be configured to illuminate the space for up to 50 employees or more. All these fixtures would typically be turned on during business hours and even after business hours, with every fixture consuming energy, even if only one or only a few employees were actually occupying various spaces within the larger illuminated zone. Even if occupancy sensors are applied to a given office or open office area as defined above—the sensor(s) typically control the same bank of lights controlled by the light switches which typically includes dozens of fixtures and not individual fixtures. Once again—the fluorescent systems do not typically dim so the entire field of lights is either on or off and not optimized. In certain applications, dual ballasts can be installed and dual switches for stepped dimming (e.g., either 50% or 100% dimming) can be used, however, such applications are generally not optimized.

There are also a number of inherent drawbacks in the current commercial light fixture offerings. The vast majority of these most common fluorescent lights contain fluorescent lamps, hazardous materials—the fluorescent lamps contain mercury, which is highly toxic, and the vast majority of the original ballasts contained PCB—another very hazardous material. While many of these ballasts and/or fixtures have been replaced—many still exist in the field and as they age the odds of these units leaking PCB increases. Additionally, the light fixtures typically cannot be dimmed to reduce energy consumption. When fixtures are modified to accept dimmers they often reduce lamp and ballast life increasing life cycle costs—in addition to the cost of adding the dimmers. Even if dimmers are added they are typically not controlling individual fixtures, but rather large interconnected banks or groups of fixtures that must all be dimmed to the same levels regardless of illumination needs in smaller zones within the switched area. Many of these fixtures are ganged on switches so they cannot be individually controlled in large installations and are typically switched in large banks or zones requiring all the lights in a zone to be turned on—even if only one workspace is actually occupied. Where new technology has been applied to existing or new light fixture installations such as sensors and controllers they are installed in very limited ways to control fixtures in large banks within an installation but they do not provide for individual controls of a fixture within a large installation and none are configured and capable of working as a series of fixtures and components within a larger networked system to optimize every fixture. Existing retrofit kits for fluorescent fixtures generally require either a) labor intensive on-site assembly of all of the components needed for LED lighting systems inside an existing light fixture housing or troffer using double stick tape or clips and then re-use of the existing lens, which is not optimized for the new lamping; or b) another labor intensive effort in the replacement of existing components with some pre-assembled components (typically 3-6 components) that require field assembly of the components overhead; or c) the complete replacement of the existing light fixtures with new light fixtures which requires removal of all or most of the ceiling tiles, significant disruption to the occupants and function of the space, removal of the existing fixtures, installation of the new fixtures with multiple seismic ties from each new fixture to the structure above and clips for the new fixture to fasten it to the grid ceiling system as well and then re-installation of all the ceiling tiles and replacement of those damaged in the process. Additionally, often times existing lenses, which are typically re-used in these replacement efforts, are not optimized for the new light systems. Many existing lenses can be cracked, discolored, and inefficient and can reduce lighting performance by as much as 50%—diminishing the performance of the new retrofit assembly and the energy savings expected.

### SUMMARY

Some of the present embodiments include high efficiency light fixtures in quick conversion kits, some with optional integrated sensors, logic and processing capabilities, controls and/or wireless communication systems that allow each light fixture to act autonomously and/or as an integrated networked system to optimize lighting conditions and reduce energy consumption. In addition, the fixtures can assist in notifying occupants of emergency conditions and guiding occupants to safe exits with optional integration of alarm systems, emergency services and/or through the use of sensors in one or any of the networked fixtures. Some of the present fixtures, for example, can both notify and guide occupants to safe exits with strobe warnings to evacuate a facility. Sequenced flashing lights moving in the direction of safe exits and flashing green lights can mark safe exits as well as a multitude of other programmable or sensor/logic driven options. Some embodiments of the present fixtures and/or systems can also notify emergency services of the exact locations within a facility of fire, collapse, trapped occupants or other emergency conditions.

Individual ones of the present fixtures used in conjunction with other similar fixtures can form a network of integrated sensors and controls that can function as a comprehensive integrated system that can operate autonomously, and/or by programmed response, integrated with various software and control applications, as a network of fixtures and sensors working together at various levels from individual, sub-group, group, master and slave, or any other hierarchy of control. The levels of control and energy management for the networked lighting systems can range from the individual light fixture, to certain fixtures with specific lighting functions, to a space being illuminated by a series of light fixtures, to an entire floor in a building, to an entire building, to a campus or group buildings out to an entire community and beyond.

The present fixtures can include a lens or lenses, sensors, logic and processing capabilities, controls, communication systems, and/or other components or systems within a universal light fixture assembly or kit. Pre-assembled ones of the present fixtures can contain all the necessary components needed for the functions defined herein. The present kits can be universal (e.g., adjustable), and/or can easily and safely replace existing less efficient light fixtures with a complete pre-assembled retrofit lens and light system that can fit into any existing manufacturer's already installed light fixture housing or troffer.

Some of the present fixtures may not require wall switches or associated wiring. In some embodiments wireless and/or wired switch(es) (e.g., low voltage, digital, and/or the like) can be provided (e.g., if required by code or otherwise desired).

At least some of the present kits can also provide manufacturers of less-efficient fixtures with a means of implementing a universal integrated fixture assembly into their existing or newly configured housing or troffer designs to sell as a new product line(s) and a more efficient assembly than they currently manufacture and can be accomplished without the need to retool or delay sales opportunities. It can also be manufactured as a standalone new fixture in a variety of sizes and installation options including but not limited to recessed, surface mounted, and other methods.

Some configurations can include the integrated sensors, controls, logic and processing capabilities and/or communication systems packaged as a stand-alone kit (optionally provided without light systems, lens and associated assemblies) to be added to existing installed or new light fixtures to create better lighting environments, lower energy consumption, and add features and functions and/or improve energy management controls for networked fixtures.

Some of the present light fixtures and optional associated sensors, logic and processing capabilities, controls and communication systems can permit a tenant, building owner and/or operator, campus, community, or others to reduce energy consumption while optimizing illumination and to achieve many other heretofore-unachievable feats.

Some of the present fixtures and/or kits can be configured in one or more of each of the configurations below which can include a variety of features, functional levels, and/or options, such as, for example, with or without sensors, logic and processing systems, controllers, communication or other equipment and/or any combination thereof. For example, a kit can be configured and installed or sold as: 1) a universal quick-change retrofit kit having a fixture with high-efficiency light source(s) (e.g., LEDs) that can quickly and cost effectively change a lower performing fixture to a higher performing fixture; 2) a universal quick-change retrofit kit having a fixture with high-efficiency light source(s) (e.g., LEDs) with on-board sensors, controls, logic, and processing capabilities, that can function as an autonomous fixture and/or as part of a group of fixtures; 3) a universal quick-change retrofit kit having a fixture with high efficiency light source(s) (e.g., LEDs), sensors, controls, logic, and processing capabilities, and wired and/or wireless communications systems which can act autonomously, as part of a group of fixtures, and/or as a broader system (e.g., network) of fixtures with on-board sensors, controls, and/or with software generated input from off-board (e.g., off-fixture) systems; 4) as a new fixture in various sizes for recessed, surface mounted, and other applications with or without the described sensors, controls, logic and processing capabilities, and/or communication systems; 5) as an OEM fixture that may be quickly be added to an existing manufacturer's troffer assemblies during production and, for example, provide a new product series with a wide range of optional functions with or without the described sensors, controls, logic and processing capabilities, and/or communication systems; and/or 6) configured as a sensor, computing unit (e.g., for logic and processing), controller, communications device, or as an assembly of sensors, components with logic and processing capabilities, controllers, and/or communications to add to new or existing fixtures for improved illumination and reduced energy consumption.

The present fixtures can act as: 1) a simple replacement fixture; or 2) as an autonomous fixture controlling its own systems and requirements; and/or 3) as an element within a network of smart light fixtures with or without external control applications and can provide numerous levels of lighting features and functions. Some of these lighting conditions include, for example: 1) general lighting; 2) exit/egress lighting; 3) night light functions; 4) emergency condition functions and others as conceived and programmed since the immense flexibility of the system is a key element in the value the system offers users. Each fixture is uniquely programmable and various fixtures can be assembled into any sub-group, group or other hierarchy imaginable and programmed, which can all be accomplished through wireless systems.

Some embodiments of the present fixtures include fully integrated sensors, logic and processing capabilities, dimmers, controls, communication systems and/or other components or systems required to achieve the functions described. These integrated systems provide the ability for each individual fixture to communicate with each other and/or a series of other remote controllers, applications, appliances, devices or other suitable means. Such embodiments can self-regulate lighting output and energy consumption and communicate with both adjacent fixtures and/or function as part of a larger “smart” lighting system within in a given installation or network(s).

Sensors may include, for example, occupancy, thermal, photocell, laser, temperature, optical, acoustic, seismic, acceleration, infrared and any number of other sensors deemed useful in the control of the individual light fixture and/or the system of lights to which it is integrated. Such sensors can also detect data that can also or alternatively be used for other control systems, such as, for example, that control window blinds, air conditioning systems, power at controlled outlets, and other functions that manage energy consumption in buildings.

The present fixtures can include reduced energy consumption lamps (LED, or other types) as well as integrated sensors (occupancy, motion, photocell, and/or others as applicable) with logic and processing capabilities (internal and/or external), dimmers and other control features which may include color temperature (degrees kelvin), visible light color selections controller, either hard-wired or wireless sensors and communication systems and controls as well as an optional integrated (and/or remote) overall master control application(s) and monitoring and/or metering system(s) for the network that can be controlled at various levels from an individual fixture or specific fixtures, to a space or spaces, a given floor in a building, the entire building, a campus or group of buildings, out to the entire community or beyond. Examples of such control applications can include, by example and without limitation, include proprietary applications, 3rd party applications, Energy Management Systems (EMS), Facility Management Systems (FMS), Facility Automation (FA) systems, Lighting Control applications, and others. Such fixtures and even networked fixture controls can be monitored and controlled down to each fixture in the network or in larger groups through wired or wireless systems and over the Internet, from a Cloud environment, hosted server farm, as well using work stations, lap tops, tablets, phones or other suitable communication appliances or devices.

By way of further example, in some embodiments, each individual light fixture can be independently controlled with and/or by its own sensors and controllers and to act autonomously from the balance of the fixtures in a given space to minimize energy consumption. For example—fixtures adjacent to a window or other light source can automatically dim or turn off as natural daylight or other light source(s) provide sufficient light levels for the space. Occupancy, motion, thermal or other sensors can determine where and when the fixture should provide higher or lower lighting levels on a fixture by fixture basis within the network of fixtures.

In addition, entire office suites, building floors or buildings and beyond can be controlled to reduced light output by a given percentage across an entire network of lights. This wireless connectivity allows the system to address “demand response” requirements from local utilities when their peak energy demand is exceeding their capacity to deliver. When a “demand response” signal is issued from a utility, the entire network of lights are to be stepped down to a given maximum percentage of output to reduce energy demand during peak use periods in a given building, campus, community or other network to prevent brownout or black out conditions and/or during emergencies such as after an earthquake. This capability is needed for building owners/managers to obtain certain rebates or incentives as partners with the utility companies. The ability to reduce energy consumption across a network of light fixtures may even become a regulatory requirement in the coming months or years. This new system is capable of providing immediate compliance since it is easily programmed for modifications, features and functions on a wireless basis, which should facilitate access to incentives and rebates to offset the cost of a system. Demand-response functions and compliance are now, or will soon be, a code requirement in some jurisdictions.

In addition, an integrated network of the present fixtures can be used to notify occupants of emergency conditions and assist occupant in exiting a facility by programming certain fixtures to function in specific configurations. Emergency lighting and emergency signals for fire, earthquake, terrorism or other conditions can cause certain fixtures to provide emergency exit lighting, while others provide warning of an emergency condition with a flashing strobe in various colors or other controlled effects. These features and functions, for example, may include integration into building alarm or notification systems such as providing strobe warning lights from certain fixtures, like red flashing lights in the case of a fire, from fixtures around the perimeter of a space warning occupants to exit the building. This can provide augmentation to the fire alarm systems audible enunciators and white strobe warnings. In addition, directional flashing lights that move in sequence toward exits to guide occupants to safe exits and providing a flashing green light to designate an exit door or safe exit passage. Sensors in these fixtures may also detect fire conditions, collapse or other hazards in specific areas of a facility and can signal control systems and emergency responders informing them as to the exact location of fire conditions or collapse. The sensors can detect if an exit or passage is potentially blocked and can re-route and change directional lights guiding occupants out of a building by re-routing them to safe exits and those exit paths that are unsafe or blocked can change from green flashing to orange flashing lights indicating a possible hazard at that exit.

Some embodiments of the present kits are configured, through mounts, mounting members, and/or trim, to retrofit an energy efficient light fixture into an existing troffer. Some embodiments of the present fixtures are configured, through a processor, one or more sensors (e.g., occupancy, light harvesting, environmental, safety, manual set up and/or the like sensors), and/or a communications device to minimize power requirements, enhance safety, communicate with others of the present kits and/or additional devices such as automated window shades and/or blinds, HVAC systems, power outlets, servers (which may run control programs), users (e.g., through a computer, tablet, and/or cell phone), and/or the like.

Some embodiments of the present systems comprise: a light fixture having a light sensor configured to capture data indicative of a lighting condition; and a processor configured to: detect the presence of a light source in data captured by the light sensor; and identify, based at least in part on data captured by the light sensor, a relative position of the light source with respect to the light fixture. In some embodiments, the processor is coupled to a frame of the light fixture. In some embodiments, the light sensor comprises a light pipe. In some embodiments, the light sensor is configured to capture data indicative of at least one of light intensity and light direction. In some embodiments, the light sensor comprises a camera.

Some embodiments of the present systems comprise: a plurality of light fixtures (each having: a light source; and a light sensor configured to capture data indicative of a lighting condition); and a processor configured to: activate the light source of a first one of the light fixtures; capture, with the light sensor of at least a second one of the light fixtures, data indicative of a lighting condition at the second one of the light fixtures; and identify, based at least in part on data captured by the light sensor of the second one of the light fixtures, a relative position of the first light fixture with respect to the second light fixture. In some embodiments, the processor is configured to compare the data indicative of the lighting condition at the second light fixture while the first light fixture is activated to data indicative of a lighting condition at the second light fixture while the first light fixture is not activated. In some embodiments, the processor is configured to identify the relative position of the first light fixture with respect to the second light fixture based on differences between the data indicative of the lighting condition at the second light fixture while the first light fixture is activated and the data indicative of the lighting condition at the second light fixture while the first light fixture is not activated, if such differences exceed a predetermined threshold.

In some embodiments of the present systems, the processor is configured to: capture, with the light sensor of a plurality of other ones of the light fixtures, data indicative of a lighting condition at the other ones of the light fixtures; and identify, based at least in part on data captured by the light sensors of the other ones of the light fixtures, a relative position of the first light fixture with respect to each of the other light fixtures. In some embodiments, the processor is configured to, for each of the other ones of the light fixtures, compare the data indicative of the lighting condition at the other light fixture while the first light fixture is activated to data indicative of a lighting condition at the other light fixture while the first light fixture is not activated. In some embodiments, the processor is configured to, for each of the other ones of the light fixtures, identify the relative position of the first light fixture with respect to the other light fixture based on differences between the data indicative of the lighting condition at the other light fixture while the first light fixture is activated and the data indicative of the lighting condition at the other light fixture while the first light fixture is not activated, if such differences exceed a predetermined threshold.

In some embodiments of the present systems, the light sensor of the one of the light fixtures comprises the light sensor of the second light fixture. In some embodiments, the processor is configured to: capture, with the light sensor of a third one of the light fixtures, data indicative of a lighting condition at the third light fixture; and identify, based at least in part on data captured by the light sensor of the third light fixture, a relative position of the first light fixture with respect to the third light fixture. In some embodiments, the processor is configured to: activate the light source of a third light fixture; capture, with the light sensor of one of the first and second light fixtures, data indicative of a lighting condition at the one of the first and second light fixtures; and identify, based at least in part on data captured by the light sensor of the one of the first and second light fixtures, a relative position of the third light fixture with respect to the one of the first and second light fixtures.

In some embodiments, the processor is coupled to a frame of at least one of the light fixtures. In some embodiments, the light sensor of at least one of the light fixtures comprises a light pipe. In some embodiments, the light sensor of at least one of the light fixtures is configured to capture data indicative of at least one of light intensity and light direction. In some embodiments, the light sensor of the at least one of the light fixtures comprises a camera.

Some embodiments of the present methods (e.g., for use in a system comprising a plurality of light fixtures, each having a light source and a light sensor configured to capture date indicative of a lighting condition) comprise: activating the light source of a first one of the light fixtures; capturing, with the light sensor of one of the light fixtures, data indicative of a lighting condition at a second one of the light fixtures; and identifying, based at least in part on data captured by the light sensor of the one of the light fixtures, a relative position of the first light fixture with respect to the second light fixture. Some embodiments further comprise: capturing, with the light sensor of a third one of the light fixtures, data indicative of a lighting condition at the third light fixture; and identifying, based at least in part on data captured by the light sensor of the third light fixture, a relative position of the first light fixture with respect to the third light fixture. Some embodiments further comprise: deactivating the light source of the first light fixture; activating the light source of a third one of the light fixtures; capturing, with the light sensor of one of the first and second light fixtures, data indicative of a lighting condition at the one of the first and second light fixtures; and identifying, based at least in part on data captured by the light sensor of the one of the first and second light fixtures, a relative position of the third light fixture with respect to the one of the first and second light fixtures.

Some embodiments of the present systems comprise: a light fixture having: a frame configured to receive a light source; a battery coupled to the frame; charging circuitry configured to selectively provide power from an external power source to the battery to charge the battery; and a processor configured to: selectively power the light source with either of the battery or the external power source; and if powering the light source with the battery, switch to the external power source to prevent the battery charge from falling below a threshold level. In some embodiments, the threshold level is a level of battery charge necessary to power the light source for a predetermined period of time. In some embodiments, the processor is configured to: power the light source with the battery during a first time period; power the light source with the external power source during a second time period; and charge the battery with the charging circuity during the second time period. In some embodiments, the first time period is an on-peak electricity time period. In some embodiments, the second time period is an off-peak electricity time period. In some embodiments, the charging circuitry is coupled to the frame of the light fixture. In some embodiments, the processor is coupled to the frame of the light fixture.

Some embodiments of the present methods comprise: powering a light source of a light fixture with a battery that is coupled to a frame of the light fixture; and switching to an external power source to power the light source if necessary to prevent the battery charge from falling below a threshold level. In some embodiments, the threshold level is a level of battery charge necessary to power the light source for a predetermined period of time. Some embodiments further comprise: powering the light source with the battery during a first time period; powering the light source with the external power source during a second time period; and charging the battery during the second time period. In some embodiments, the first time period is an on-peak electricity time period. In some embodiments, the second time period is an off-peak electricity time period.

Some embodiments of the present systems comprise: a first light fixture having: a frame configured to receive a light source; and a communications device coupled to the frame (and configured to: detect a presence of a user device; and determine an identifier associated with the user device); and a processor configured to control, based at least in part on one or more settings associated with the identifier, the light source to vary a lighting condition. In some embodiments, the processor is coupled to the frame of the first light fixture. In some embodiments, the communications device comprises a Bluetooth radio. Some embodiments further comprise; a second light fixture having: a frame configured to receive a light source; and a communications device coupled to the frame (and configured to: detect a presence of a user device; and determine an identifier associated with the user device); where the processor is configured to control the first and second light fixtures to vary a lighting condition, based at least in part on one or more settings associated with an identifier determined by at least one of the first and second light fixtures.

Some embodiments of the present methods comprise: detecting a presence of a user device with a communications device coupled to a frame of a light fixture having a light source; determining an identifier associated with the user device; and controlling the light source to vary a lighting condition, based at least in part on one or more settings associated with the identifier. Some embodiments further comprise: controlling a light source of at least one other light fixture to vary a lighting condition, based at least in part on the one or more settings associated with the identifier. In some embodiments, the identifier associated with the user device comprises a media access control (MAC) address.

Some embodiments of the present systems comprise: a wireless network controller configured to control access to a wireless first network; and a plurality of lighting components, each connectable to the wireless first network and including: a plurality of light fixtures (each having: a frame configured to receive a light source; a wireless communications device coupled to the frame and configured to receive a command indicative of a desired lighting condition via the wireless first network; and a processor coupled to the frame and configured to control, based at least in part on the received command, the light source); where the wireless network controller is configured to prevent personal user devices from directly communicating over the wireless first network. In some embodiments, the wireless network controller is configured to: receive a first command indicative of a desired lighting condition from a personal user device; transmit a second command indicative of the desired lighting condition to one or more of the lighting components over the wireless first network. In some embodiments, the wireless network controller is configured to receive the first command over a second network that is a subnetwork of the wireless first network. Some embodiments further comprise: a server connectable to a second network, the server configured to: receive a first command indicative of a desired lighting condition from a personal user device over the second network; and transmit a second command indicative of the desired lighting condition to the wireless network controller. In some embodiments, the second network comprises the Internet. In some embodiments, the server is configured to provide a web-based user interface. In some embodiments, the wireless first network comprises an encrypted wireless network. In some embodiments, the wireless network controller comprises a virtual private network (VPN) gateway router. In some embodiments, the communications device of at least one of the lighting components comprises the wireless network controller. In some embodiments, the plurality of lighting components includes a light switch. In some embodiments, each of the light fixtures includes a memory coupled to the frame and storing a public key and a private key. In some embodiments, each of the lighting components includes a memory storing a private key. In some embodiments, at least one of the plurality of lighting components is configured to communicate using a constrained application protocol (CoAP). In some embodiments, personal user devices include at least one of: a cellular phone, a tablet, a personal computer, and a laptop. In some embodiments, at least one of the light fixtures comprises one or more sensors coupled to the frame, each configured to capture data indicative of an environmental condition; and the processor of the at least one light fixture is configured to control, based at least in part on data captured by the one or more sensors, the light source of the light fixture. In some embodiments, the wireless communications device of the at least one light fixture is configured to transmit a command indicative of a desired lighting condition over the wireless first network to the wireless communications device of at least one other of the light fixtures, based at least in part on data captured by the one or more sensors.

Some embodiments of the present systems comprise: a kinetic switch configured to: receive a physical user input; and convert the physical user input, using a power associated with the physical user input, into an electrical signal indicative of the physical user input; and a plurality of light fixtures including: at least one slave light fixture; and a master light fixture having a communications device configured to: receive a first electrical signal indicative of a desired lighting condition from the kinetic switch; and communicate a second electrical signal indicative of the desired lighting condition to the at least one slave light fixture. In some embodiments, the second electrical signal includes a temporal component indicative of a time upon which to produce the desired lighting condition. In some embodiments, the communications device of the master light fixture is configured to receive the first electrical signal over at least one of a wired connection and a wireless connection. In some embodiments, the communications device of the master light fixture is configured to communicate the second electrical signal to the at least one slave light fixture over at least one of a wired connection and a wireless connection.

Some embodiments of the present methods comprise: receiving, with a master light fixture and from a kinetic switch, a first electrical signal indicative of a desired lighting condition, the kinetic switch configured to receive a physical user input, and convert the physical user input, using a power associated with the physical user input, into an electrical signal indicative of the physical user input; communicating, from the master light fixture and to at least one slave light fixture, a second electrical signal indicative of the desired lighting condition; activating the master light fixture, based at least in part on the first electrical signal; and activating the at least one slave light fixture, based at least in part on the second electrical signal. Some embodiments further comprise delaying activation of the master light fixture and the at least one slave light fixture until a specified time such that the master light fixture and the at least one slave light fixture are each activated substantially simultaneously. In some embodiments, the second electrical signal includes a temporal component indicative of the specified time.

Some embodiments of the present light fixtures comprise: a frame configured to receive a light source; and a communications device coupled to the frame and configured to: connect to a wireless network; and permit a user to wirelessly access the wireless network via the communications device.

Some embodiments of the present light fixtures comprise: a frame configured to receive a light source; and a communications device coupled to the frame and comprising: a reception antenna configured to receive a cellular signal; an amplifier configured to increase the power of the cellular signal to produce an increased power cellular signal; and a broadcast antenna configured to broadcast the increased power cellular signal.

In some embodiments of the present mounts configured to support a frame of a light fixture relative to a troffer, the troffer having a sidewall extending between a first end having an upper wall and a second end defining an opening, the mount comprises: a first mount member having a first mounting surface couplable to the troffer; and a second mount member having: a second mounting surface; and protrusion extending away from the second mounting surface; where the second mount member is couplable to the first mount member via the second mounting surface such that: the protrusion of the second mount member extends away from the sidewall of the troffer and is spaced apart from the second end of the troffer; and the second mount member is adjustable relative to the first mount member to vary the distance between the protrusion and the second end of the troffer. In some embodiments, the first mount member is couplable to the upper wall of the troffer. In some embodiments, the second mount member comprises a leg portion configured to set a minimum distance between the protrusion and the second end of the troffer.

Some embodiments of the present systems comprise: a light fixture (comprising: a frame configured to receive a light source; and an acoustic sensor coupled to the frame and configured to capture data indicative of acoustic signals in an environment); and a processor configured to: compare at least a portion of the data captured by the acoustic sensor with one or more predetermined acoustic signals to determine if the at least a portion of the data captured by the acoustic sensor indicates an occupancy in the environment; and activate the light source if the at least a portion of the data captured by the acoustic sensor indicates an occupancy in the environment. Some embodiments of the present systems comprise: an optical sensor configured to capture data indicative of objects in the environment; where the processor is configured to activate the light source if the data captured by the optical sensor indicates an occupancy in the environment. In some embodiments, the processor is configured to deactivate the light source of the light fixture if neither the data captured by the optical sensor nor the data captured by the acoustic sensor indicates an occupancy in the environment. In some embodiments, the optical sensor comprises a passive infrared sensor. In some embodiments, the processor is coupled to the frame. Some embodiments further comprise: a memory configured to store data indicative of the one or more predetermined acoustic signals.

Some embodiments of the present methods (e.g., for controlling a light source) comprise: capturing, with an acoustic sensor, data indicative of acoustic signals in an environment; determining whether at least a portion of the data captured by the acoustic sensor is indicative of an occupancy in the environment; capturing, with an optical sensor, data indicative of objects in the environment; activating the light source if the at least a portion of the data captured by the acoustic sensor or the data captured by the optical sensor indicates an occupancy in the environment; and deactivating the light source if neither the at least a portion of the data captured by the acoustic sensor nor the data captured by the optical sensor indicates an occupancy in the environment. In some embodiments, determining whether at least a portion of the data captured by the acoustic sensor is indicative of an occupancy in the environment comprises comparing at least a portion of the data captured by the acoustic sensor with one or more predetermined acoustic signals indicative of an occupancy in the environment.

Some embodiments of the present systems comprise: a processor configured to communicate signals, each having a duty cycle; a light fixture having: a frame configured to receive a light source; and a light driver for powering the light source and having a memory for storing one or more configuration settings associated with the light driver, the light driver configured to: receive a signal from the processor; if the duty cycle of the signal is above a threshold duty cycle, power the light source, based at least in part on the signal received from the processor; and if the duty cycle of the signal is below the threshold duty cycle, allow changes to the one or more configuration settings stored in the memory, based at least in part on subsequent signals received from the processor.

Some embodiments of the present methods comprise: communicating one or more signals, each having a duty cycle, to a light driver configured to power a light source (the one or more signals including: a first signal having a first duty cycle, and a second signal subsequent to the first signal and having a second duty cycle); powering the light source, based at least in part on at least one of the first signal and the second signal, if the first duty cycle is above a threshold duty cycle; and allowing changes to (e.g., changing) one or more configuration settings of the light driver, based at least in part on the second signal, if the first duty cycle is below the threshold duty cycle.

Some embodiments of the present system comprise: a plurality of light fixtures each configured to receive a signal from an object; a processor coupled to each of the plurality of light fixtures and configured to receive signals from the plurality of light fixtures; to determine three signals with the strongest signal strength and the corresponding three light fixtures; and to determine a location of the object relative to the three light fixtures based on a comparison of strengths of the three signals.

Some embodiments of the present methods comprise: receiving, at each of a plurality of light fixtures, a signal from an object; communicating the received signals to a processor; determining, at the processor, three signals with the strongest signal strength and the corresponding three light fixtures; and determining, at the processor, a location of the object relative to the three light fixtures based on a comparison of strengths of the three signals.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, an apparatus that “comprises,” “has,” “includes,” or “contains” one or more elements possesses those one or more elements, but is not limited to possessing only those elements. Likewise, a method that “comprises,” “has,” “includes,” or “contains” one or more steps possesses those one or more steps, but is not limited to possessing only those one or more steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiment depicted in the figures.

FIG. 1 depicts a perspective view of a prior art troffer.

FIGS. 2A and 2B depict cross-sectional end views of one embodiment of the present kits.

FIGS. 3A and 3B depict a side and end view, respectively, of one embodiment of the present mounts, which may be suitable for use in some embodiments of the present kits.

FIGS. 3C and 3D depict a side and end view, respectively, of another embodiment of the present mounts, which may be suitable for use in some embodiments of the present kits.

FIG. 4A depicts a cross-sectional end view of the kit of FIGS. 2A and 2B.

FIGS. 4B and 4C depict cross-sectional views of some embodiments of the present mounting members.

FIGS. 5A-5C depict cross-sectional end views of the kit of FIGS. 2A and 2B at various stages during installation of a frame into a troffer.

FIGS. 6A-6B depict one embodiment of the present frames.

FIGS. 6C-6D depict an alternate method for mounting one of the present frames to a troffer.

FIGS. 7A-7C depict various lenses and lens configurations suitable for use with the frame of FIGS. 6A and 6B.

FIG. 8 is a block diagram depicting certain components of some embodiments of the present fixtures.

FIG. 9 is a conceptual diagram depicting some components of FIG. 8.

FIGS. 10A and 10B are each a flow diagram depicting a respective embodiment of the present methods (e.g., for power management).

FIGS. 11A-11E are block diagrams depicting various embodiments of the present switches and/or controllers.

FIGS. 12A-B depict a respective embodiment of the present systems (e.g., for fixture control), which may be suitable for use with some embodiments of the present fixtures.

FIG. 13 depicts one embodiment of the present methods (e.g., for fixture control and/or configuration).

FIG. 14 depicts one embodiment of the present methods (e.g., for fixture control).

FIGS. 15A-B and 16 each depict a respective operation of certain functions of some embodiments of the present fixtures.

FIG. 17A depicts one embodiment of the present systems (e.g., for fixture mapping), which may be suitable for use with some embodiments of the present fixtures.

FIG. 17B is a flow diagram depicting one embodiment of the present methods (e.g., for detecting and/or locating a light source).

FIG. 17C illustrates various embodiments of the present methods (e.g., for detecting and/or locating a light source).

FIGS. 17D and 17E are each a flow diagram depicting a respective embodiment of the present methods (e.g., for fixture mapping).

FIG. 18 depicts an example of a network environment suitable for use with some embodiments of the present fixtures.

FIG. 19 depicts one embodiment of the present systems (e.g., for fixture networking), which may be suitable for use with some embodiments of the present fixtures.

FIGS. 20A-20B depict one embodiment of a system for estimating a location of an object using the present fixtures.

FIG. 21 depicts one embodiment of a pattern to deploy fixtures for estimating locations of an object.

FIG. 22 depicts one embodiment of a method for estimating locations of an object using fixtures.

### DETAILED DESCRIPTION OF ILLUSTRATIVE EMBODIMENTS

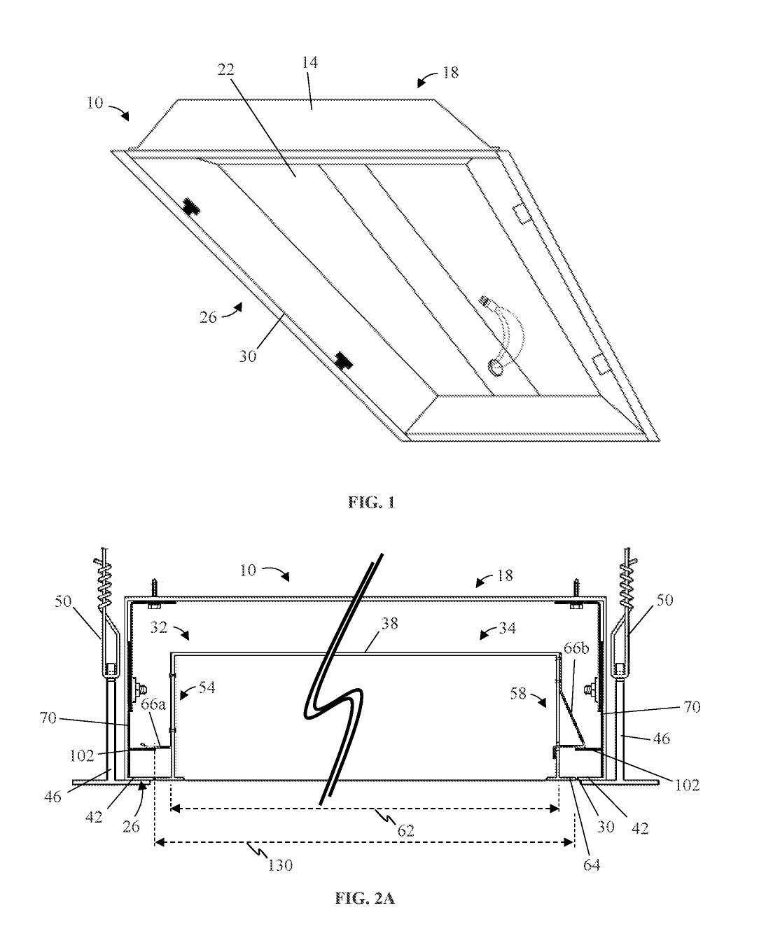

FIG. 1 depicts a perspective view of a prior-art troffer 10. Troffer 10 is depicted by way of example, and not by way of limitation, and a person of ordinary skill in the art will understand that various troffers (e.g., comprising various shapes, sizes, and/or configurations) are suitable for receiving retrofit kits in accordance with the teachings of the present disclosure. In the example shown, troffer 10 has a sidewall 14 extending between a first end 18 having an upper wall 22 and a second end 26 defining an opening 30.

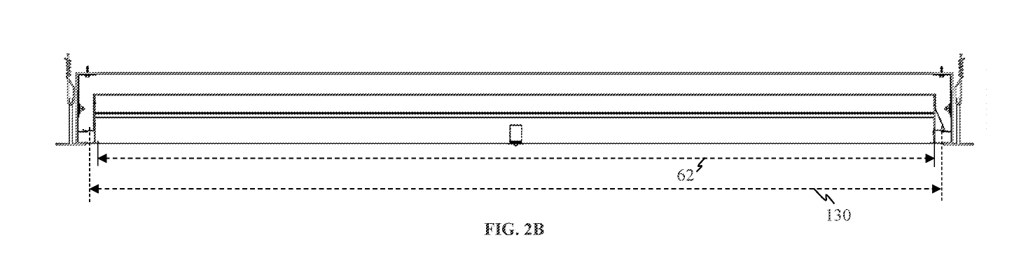

FIG. 2A depicts a cross-sectional end view of troffer 10 with one embodiment 32 of the present retrofit kits (including a fixture 34) disposed therein. FIG. 2A shows frame 38 and troffer 10 truncated, as indicated by the break lines, in order to clearly indicate certain features. FIG. 2B depicts a similar view of a same or a similar kit, shown drawn to scale (e.g., for at least some embodiments). In the depicted embodiment, second end 26 of troffer 10 includes a lower horizontal shelf portion 42 that extends into the troffer and bounds at least a portion of opening 30. As shown, horizontal shelf portion 42 can be configured to rest against and/or be coupled to a T-bar frame 46 of a suspended ceiling grid (e.g., hung via suspension members 50, as shown).

In the embodiment shown, fixture 34 comprises a frame 38 configured to receive a light fixture (or light fixtures) (e.g., a plurality of light-emitting-diodes (LEDs)), as described in more detail below. In the embodiment shown, frame 38 has a first side 54, a second side 58, and a frame length 62 extending between the first and second sides (e.g., as shown, excluding a trim portion or flange 64). In the embodiment shown, kit 32 comprises a first mounting member 66a coupled to frame 38 (e.g., through fasteners such as screws, bolts, rivets, welds, and/or the like, interlocking features of the frame and/or mounting member, welding, adhesives, and/or the like) and configured to extend beyond first side 54 of frame 38 (though not necessarily beyond trim portion or flange 64). In the embodiment shown, and as described in more detail below, first mounting member 66a is configured to support first side 54 of frame 38 relative to troffer 10 (e.g., in the orientation shown). In this embodiment, kit 32 further comprises a second mounting member 66b coupled to frame 38 and configured to extend beyond second side 58 of frame 38 (though not necessarily beyond trim portion or flange 64). In the depicted embodiment, and as described in more detail below, second mounting member 66b is configured to support second side 58 of frame 38 relative to troffer 10 (e.g., in the orientation shown). In some embodiments, such as in kit 32, supporting of first and second sides, 54 and 58, respectively, of frame 38 relative to troffer 10 can be accomplished alternatively and/or additionally through use of mounts, such as mounts 70 (e.g., two or more mounts 70, as shown), as described in more detail below. The inclusion and/or number of mounts (e.g., 70), and/or the number and/or configuration of mounting members (e.g., 66a, 66b, and/or the like) can be selected depending on, for example, the shape, size, and/or configuration of an existing troffer (e.g., 10) (e.g., if installing the present kits as a retrofit).

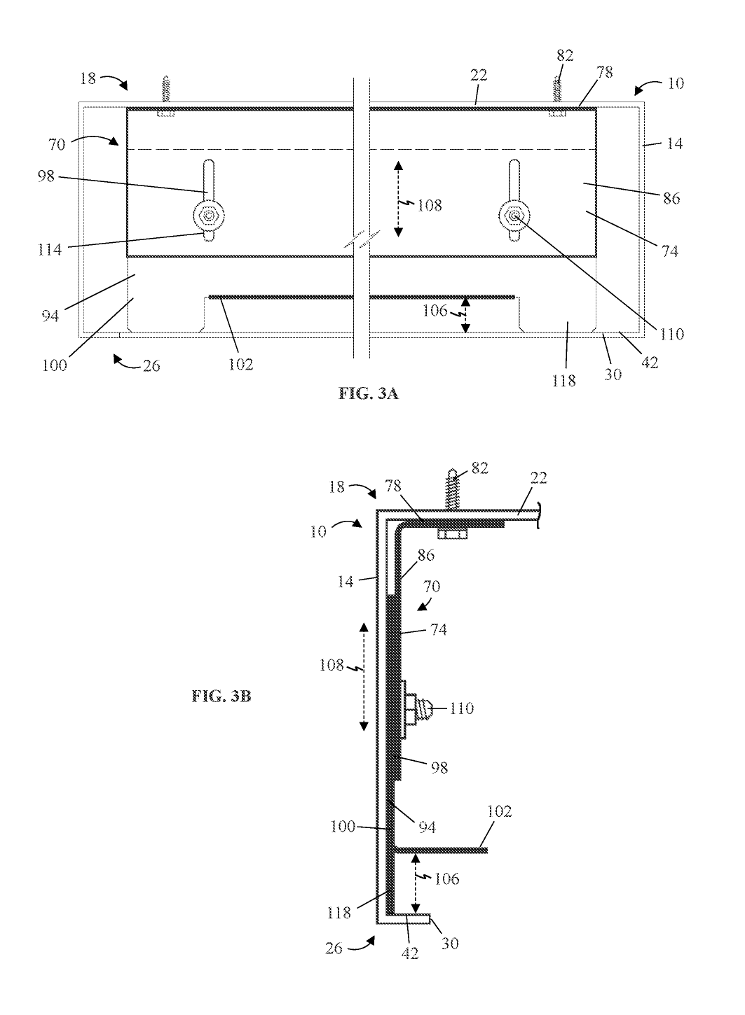

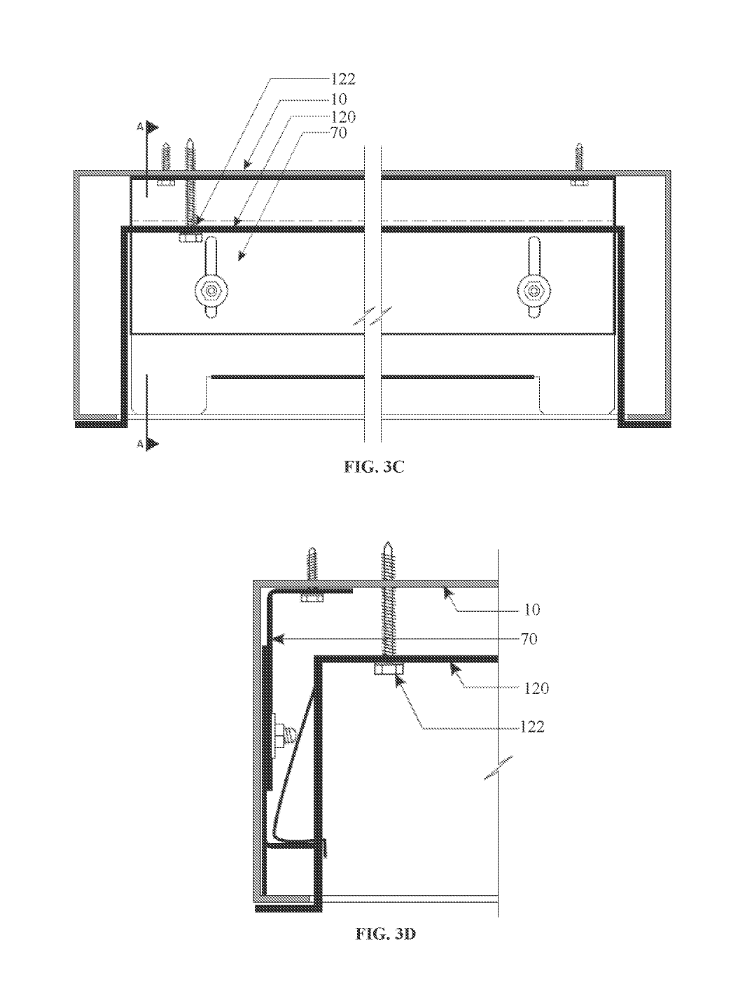

FIGS. 3A and 3B depict various views of one embodiment of the present mounts, which may be suitable for use in some embodiments of the present kits (e.g., kit 32). In particular, FIG. 3A is side view of mount 70 coupled to troffer 10, and FIG. 3B depicts an end view of mount 70 coupled to troffer 10. In the embodiment shown, mount 70 comprises first mount member 74 having a mounting surface 78 for coupling the mount to a troffer, such as troffer 10, as shown (e.g., via one or more fasteners 82). In this embodiment, first mount member 74 is couplable to upper wall 22 of troffer 10. For example, in the depicted embodiment, mounting surface 78 extends away from a generally planar body 86 of first mount member 74 at a non-parallel angle (e.g., 90 degrees, in the embodiment shown), such that, for example, the mounting surface can be coupled to upper wall 22 and body 86 can extend away from the upper wall to support a fixture (e.g., 34) disposed within troffer 10. In this embodiment, body 86 is unitary with mounting surface 78 (e.g., a portion of second mount member 94 that defines the second mounting surface) (e.g., the body and the mounting surface may be defined by a single piece or sheet of material, with the mounting surface being bent away from the body). In these ways and others, for example, mount 70 may be used to support a fixture (e.g., 34) relative to troffer 10, without requiring fasteners disposed through sidewall 14 of the troffer (e.g., providing for a hidden or substantially hidden mount installation, particularly when installing the fixture within a surface mounted troffer, and/or the like) and/or without requiring the mount, or portions thereof, to be fastened to or in contact with the sidewall (e.g., allowing for fixtures 34 of various length to be installed into troffers 10 of various lengths).

In this embodiment, mount 70 includes a second mount member 94 having a second mounting surface 98 for coupling the second mount member to first mount member 74. In the depicted embodiment, second mount member 94 includes a generally planar body 100 and defines a protrusion 102 extending away from the body in a direction away from second mounting surface 78 (e.g., to define a shelf relative to which a fixture 34 may be supported). In the embodiment shown, second mount member 94 is couplable to first mount member 74 such that protrusion 102 extends away from sidewall 14 of troffer 10 when the first mount member is coupled to the troffer and is spaced apart from second end 26 of the troffer by a distance 106 (e.g., an adjustable distance, as described below) (e.g., within the range of about 0.25 inches to about 2.5 inches, for example, between 0.7 and 1.5 inches).

In this embodiment, second mount member 94 is adjustable relative to first mount member 74 such that distance 106 between protrusion 102 and second end 26 is adjustable (e.g., generally along a direction indicated by 108). For example, in the depicted embodiment, second mount member 94 is configured to be slidably coupled to first mount member 74. To illustrate, in the embodiment shown, second mount member 94 includes one or more fasteners 110 (e.g., threaded studs) extending from body 86, each configured to be received by one or more slots 114 defined by body 100 of first mount member 74. In this way, second mount member 94 may move relative to first mount member 74, guided by one or more fasteners 110 within one or more slots 114 to adjust distance 106. In this embodiment, one or more fasteners 110 may be tightened (e.g., by threading each of one or more nuts onto a respective one of one or more fasteners) to releasably secure second mount member 94 relative to first mount member 74. In this embodiment, each of one or more slots 114 is bounded (e.g., a perimeter of each of the one or more slots is defined completely by first mount member 74); however, in other embodiments, each of one or more slots (e.g., 114) may extend through an end of a first mount member (e.g., 74) (e.g., to facilitate coupling of a second mount member 94 to the first mount member, when the first mount member is coupled to a troffer 10). In other embodiments, one or more fasteners (e.g., 110) may be a component of a first mount member (e.g., 74) (e.g., as opposed to a second mount member 94), and one or more slots (e.g., 114) may be a component of the first mount member (e.g., such that the first mount member is configured to be disposed between a troffer 10 and the second mount member). In these ways and others, mount 70 may be configured to install fixtures of various heights to be installed into troffers 10 of various heights.

In the embodiment shown, second mount member 94 comprises a leg portion 118 configured to set a minimum distance 106 between protrusion 102 and second end 26 of troffer 10 (e.g., by contacting a portion of the troffer, such as horizontal shelf portion 42, when the protrusion is at the minimum distance relative to the second end of the troffer). In some embodiments (e.g., 34), such functionality may be accomplished alternatively or additionally by a length of one or more slots (e.g., 114). In this embodiment, leg portion 118 and protrusion 102 are unitary with body 100 (e.g., the protrusion, leg portion, and body are formed from a single piece or sheet of material, for example, with the protrusion being bent away from body).

The present mounts (e.g., 70) can function as and/or comprise a universal mounting platform that can be configured (e.g., through the structure described above) to install the present fixtures (e.g., 34) at an adjustable height relative to a troffer (e.g., 10) (e.g., through configuration and/or location of first mount member 74 relative to second mount member 94). For example, through such structure, the present fixtures can be installed such that the lens plane (e.g., defined by the open portion of frame 38 facing away from troffer 10) can align in the same or substantially the same plane as the ceiling and/or the existing troffer (e.g., such that the fixtures can fit substantially “flush” with the ceiling, if desired).

In some embodiments, as shown in FIGS. 3C and 3D, kit 32 further includes an anchor 120 configured to mount fixture 34 to troffer 10. In this embodiment, at least a portion of sidewalls 14 of troffer 10 may be disposed below the plane of the ceiling. For example anchor 120 is couplable to troffer 10 using at least one fastener 122, such as a screw. Fasteners 122 may be vertically oriented and pass through an upper wall of anchor 120 and an upper wall 22 of troffer 10. In some embodiments, fasteners 122 may be disposed towards opposing corners of anchor 120. Any appropriate number of fasteners 112 may be used to couple anchor 120 and troffer 10, such as 2, 4, 6, 8, or 10.

As best shown in FIG. 2A, at least two of the present mounts (e.g., mount 70) can be configured to be coupled to a troffer 10 on generally opposing sides of the troffer such that a transverse distance between respective protrusions 102 of the at least two mounts defines a mount opening length 130 that is substantially equal to or less than a frame length (e.g., 62) of a fixture (e.g., 34) to be installed within the troffer via the at least two mounts (e.g., via varying a length associated with the respective protrusions, varying placement of the at least two mounts relative to one another, and/or the like). Also depicted in FIGS. 2A and 2B, in the embodiment shown, mounting member 66a is configured to contact a protrusion 102 of a mount 70 coupled to troffer 10 to support first side 54 of frame 38 (e.g., by preventing first side 54 from inadvertently falling out and/or otherwise becoming dislodged from troffer 10). In this embodiment, second mounting member 66b is configured to contact a protrusion 102 of a mount 70 coupled to troffer 10 to support second side 58 of frame 38 (e.g., in a similar or in the same fashion). In some embodiments, a mounting member 66b may be used in place of mounting member 66a (e.g., such that only mounting members 66b are included).

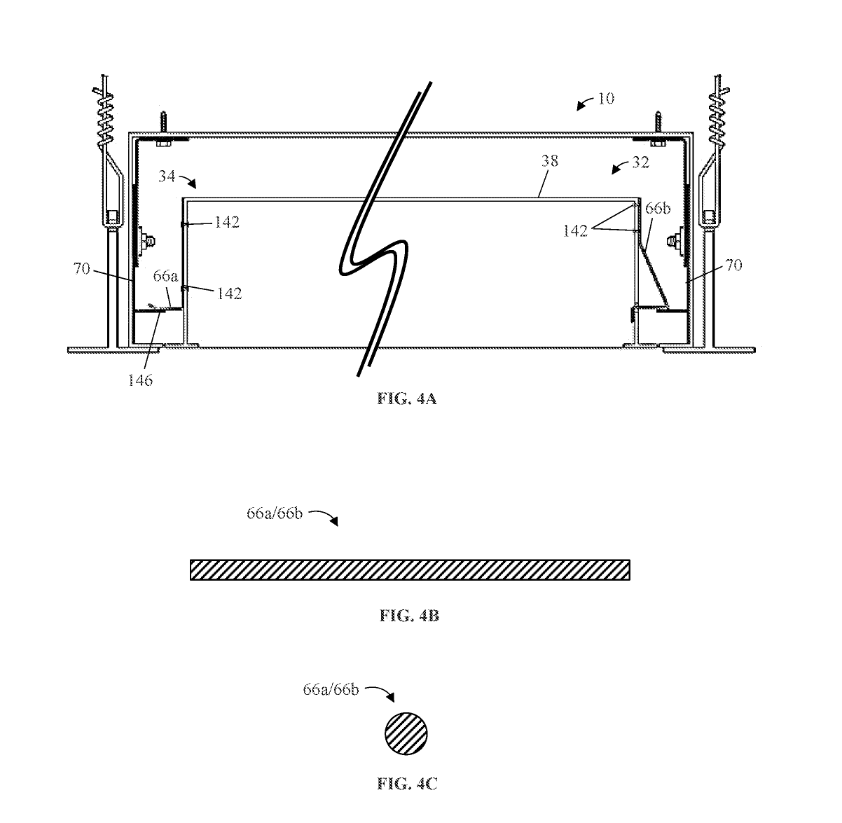

Provided by way of example, FIG. 4A depicts a view that is similar to that of FIG. 2A, with the middle portions of frame 38 and troffer 10 cut away. In the embodiment shown, first mounting member 66a is coupled in fixed relation to frame 38 (e.g., coupled with fasteners 142 at two locations, as shown, to substantially prevent movement of mounting member 66a relative to frame 38 when the mounting member is coupled to the frame), and extends outwardly from the frame (e.g., portion 146 extends away from the frame). Fasteners 142 can comprise any suitable fasteners that permit the functionality described in this disclosure, including, but not limited to, screws, bolts, rivets, pins, clips, and/or the like. As shown in FIGS. 4B and 4C, mounting members 66a and/or 66b can comprise any suitable cross-sectional shape that permits the functionality described in this disclosure, including, but not limited to, flat (e.g., or substantially flat) as shown in FIG. 4B, round (e.g., or rounded) as shown in FIG. 4C, triangular, rectangular, or otherwise polygonal, and/or the like.

Additionally, in some embodiments, the coupling of mounting member 66a and/or 66b to frame 38 can be adjustable (e.g., configured to secure the frame relative to a wide variety of troffers, in a universal fashion). For example, frame 38 and/or mounting members 66a and/or 66b may be slotted at locations configured to receive fasteners 142 such that the mounting members are permitted to move (e.g., slide) relative to frame 38 (e.g., in at least a downward direction) before the fasteners are tightened and the mounting members are secured. In these ways and others, the position of mounting members 66a and/or 66b relative to frame 38 can be finely adjusted prior to inserting the frame into a troffer (e.g., 10), thus facilitating a desired orientation of the frame (e.g., and thus a fixture 34 comprising the frame) relative to the troffer and/or the ceiling (e.g., such that the fixture, kit, and/or frame can be substantially “flush” and/or parallel with the ceiling, if desired).

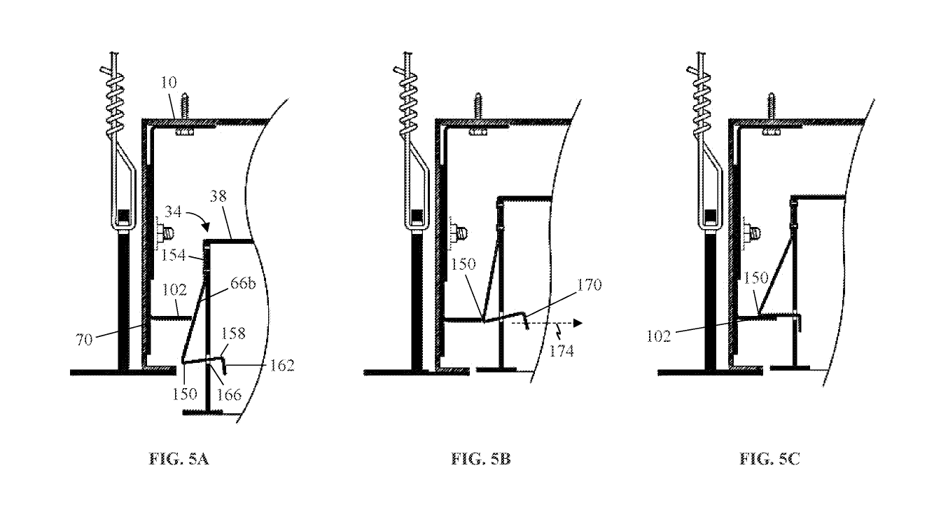

FIGS. 5A-5B depict the operation of mounting member 66b (e.g., during installation of frame 38 into troffer 10). In the embodiment shown, mounting member 66b has at least a portion, such as distal end 150, configured to move between an extended first position (e.g., FIG. 5C) and a retracted second position (e.g., FIG. 5B, however, mounting member 66b can be configured to retract further, e.g., to a point where mounting member 66b lies substantially against frame 38). In the retracted second position of mounting member 66b (e.g., shown in FIG. 5B), a distance between first side 54 of frame 38 (shown in FIGS. 2A and 2B), and distal end 150 of mounting member 66b is substantially equal to or less than mount opening length 130 (e.g., to permit insertion of frame 38 with mounting member 66b into troffer 10). In the embodiment shown, mounting member 66b comprises a spring (e.g., or is spring-like) with an upper end 154 fixed (e.g., coupled) to frame 38 (e.g., at second side 58, as shown in FIG. 2A). Such fixing or coupling can be accomplished in the same or a similar manner as described above for mounting member 66a (e.g., via fasteners 142). In the embodiment shown, mounting member 66b further comprises a lower end 158 which is movable relative to frame 38 (e.g., second side 58). Through configuration of mounting member 66b (e.g., spring properties), mounting member 66b can be biased towards the extended first position (shown in FIG. 5C) (e.g., such that mounting member 66b resists retraction). In the embodiment shown, a proximal end 162 of mounting member 66b extends through a side wall of frame 38 (e.g., through hole or slot 166) into an interior of the frame such that a user can pull the proximal end towards first side 54 of the frame to move the mounting member to the retracted second position (e.g., such pulling can be facilitated by tab 170, FIG. 5B). A user may slide the frame into troffer 10 (e.g., FIG. 5A) by extending first side 54 of the frame into the troffer such that mounting member 66a extends over protrusion 102 of a mount 70 and, as shown, displacing mounting member 66b into the retracted position shown in FIG. 5B. When mounting member 66b (e.g., distal end 150) is in the appropriate position (e.g., past a protrusion 102 of a mount 70), mounting member 66b can displace to an extended first position, as shown in FIG. 5C (e.g., “snap” into place). A user can remove frame 38 from troffer 10 by applying force to tab 170 (e.g., generally in direction 174), thus displacing mounting member to a retracted position such that frame 38 can be removed from the troffer (e.g., position shown in 5B).

The present mounts and/or mounting members can be configured (e.g., as described above) to provide for easy removal and/or installation of the present kits and/or fixtures, and thus easy maintenance, upgrade, repair and/or other service, and/or otherwise easy access to the fixtures and/or troffers. The foregoing description of mounting members (e.g., 62a, 62b, and/or the like) is provided by way of example and not by limitation. Additionally, kits and/or fixtures (e.g., whether new or retrofit) can comprise any suitable number of mounting members in any suitable configuration (e.g., some or all comprising mounting member 62b (e.g., “spring clips”), some or all comprising mounting member 62a (e.g., “fixed clips”), or any other configuration, for example, with other mounting members that may be similar to mounting members described above).

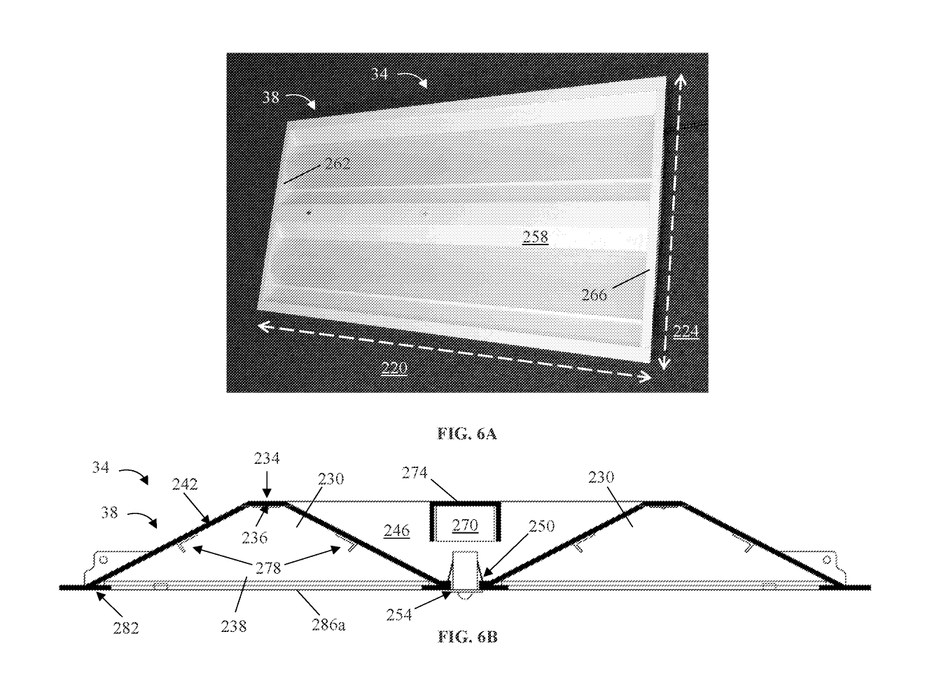

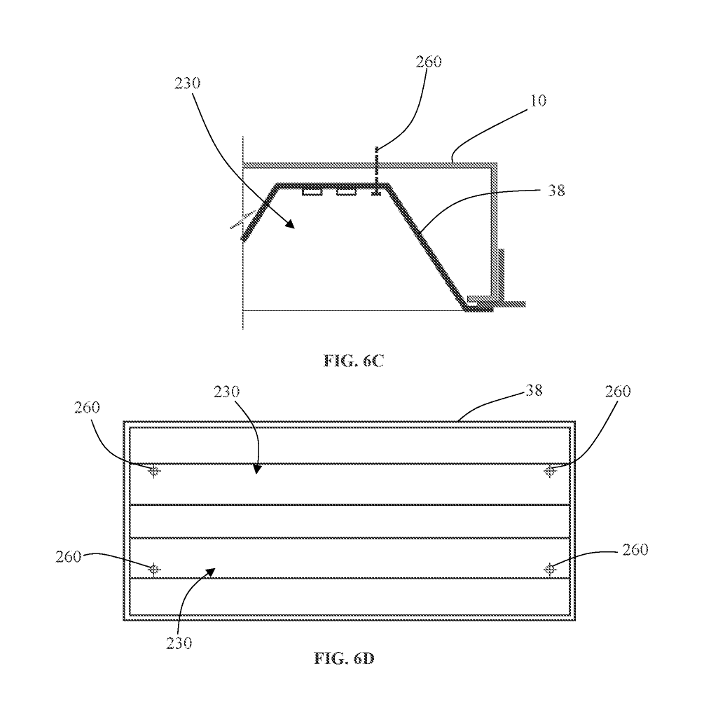

FIG. 6A is a perspective view of frame 38, which is suitable for use in the present fixtures (e.g., 34). Frame 38 is generally configured to fit within (e.g., be coupled to) an existing troffer (e.g., such that the present kits can be used for retrofit purposes inside a standard sized troffer). For example, frame 38 has nominal dimensions of a length 220 of 4 feet (ft) and a width 224 of 2 ft. In other embodiments, the frame can have any dimensions which permit the functionality described in this disclosure, for example, nominal dimensions of 2 ft by 2 ft, or 1 ft by 4 ft, or other dimensions that may be smaller or larger in length and/or width (e.g., any size which may, for example, be configured to fit within an existing troffer). FIG. 6B depicts a cross-sectional end view of frame 38. In the embodiment shown, frame 38 defines an inverted channel 230 (e.g., two (2) inverted channels 230 which are elongated). Other embodiments can comprise any number of inverted channels, for example, 1, 2, 3, 4, 5, 6, or more inverted channels 230. Inverted channel(s) 230 comprise a cross-sectional shape (e.g., as shown) that includes an upper end 234 and a lower end 238 that is wider than the upper end, with sides 242 (e.g., first and second sides) between the upper and lower ends.

FIG. 6C depicts a cross sectional view of frame 38 coupled to troffer 10 using at least one fastener 260, such as a screw, bolt, special bracket and/or anchor. Fastener 260 may be vertically oriented and pass through at least frame 38, such as at upper end 234, and upper wall 22 of troffer 10. In this embodiment, mount 70 may not be required.

In the embodiment shown, frame 38 is configured to receive (e.g., be coupled to and/or comprise) one or more (e.g., a plurality of) light sources (e.g., a plurality of light-emitting diodes (LEDs)) within inverted channel(s) 230, for example, at location 236, which may be internal to channel(s) 230 and adjacent upper end 234).

First and second sides 242 of inverted channel 230 can further comprise reflector surfaces that face into the channel (e.g., to control and/or direct light within inverted channel 130). In the embodiment shown, frame 38 further comprises a sensor bay 246 disposed between and/or defined by the inverted channels 230 (e.g., a centralized sensor bay). In the embodiment shown, sensor bay 246 has a mounting location 250 (e.g., or multiple mounting locations, with some embodiments having centralized sensor mounting locations, as shown) configured to be coupled to one or more sensors 254 (described in more detail below) (e.g., by using fasteners, such as nuts, bolts, screws, rivets, snaps, clips and/or the like, tape such as double-sided tape, adhesives, such as glue, interlocking features between sensor(s) 254 and/or mounting location(s) 250, a friction fit between sensor(s) 254 and/or mounting location(s) 250, and/or the like. In the embodiment shown, at least a portion of one of the first and second sides 242 of one of the inverted channels 230 defines at least a portion of the sensor bay 246 (e.g., as shown). For example, in the embodiment shown, a single piece of sheet metal defines at least a portion of inverted channel(s) 230 and the sensor bay (e.g., sensor bay 246 shares a wall with at least one inverted channel 230). The present frames can be constructed in any suitable fashion using any suitable material (e.g., sheet metal) in any suitable quantity. For example, in the embodiment shown, frame 38 is constructed from a first piece 258 of sheet metal that defines the cross-sectional shape of inverted channel 230, second and third pieces (262 and 266 respectively) of sheet metal enclosing first and second ends of the inverted channels (e.g., as shown).

In the embodiment shown, frame 38 further comprises a component bridge 270 (e.g., which may comprise and/or be defined by a fourth piece 274 of sheet metal that is coupled to at least one of the second and third pieces of sheet metal). For further example, in other embodiments, frame 38 can comprise a single piece of sheet metal that defines at least a portion of the cross-sectional shape of inverted channel(s) 230, encloses at least a portion of the first and second ends of the inverted channels (e.g., in a same or substantially similar fashion to as described for second and third pieces 262 and 266 above), and defines at least a portion of component bridge 270. Component bridge 270 can be configured to be coupled to control and/or communications components and/or driving components for the light sources (e.g., components described in more detail below). In the embodiment shown, component bridge 270 has a length extending substantially parallel to a length of the inverted channels (e.g., as shown in FIG. 6B). However, in other embodiments, component bridge 270 can have a length extending substantially perpendicular to a length of the inverted channels 230 (e.g., and be coupled to and/or between inverted channels 230 on sides 242 at any point between upper end 234 and lower end 238, and, in some embodiments, may transect an inverted channel (e.g., to at least partially define two inverted channels having lengths that extend substantially along the same axis) and/or define a boundary between two inverted channels). The present fixtures can comprise any suitable number of component bridges (e.g., 1, 2, 3, 4, or more component bridges, in any suitable configuration (e.g., extending parallel with inverted channels 230, extending perpendicular to inverted channels 230, and/or otherwise angularly disposed relative to inverted channels 230).

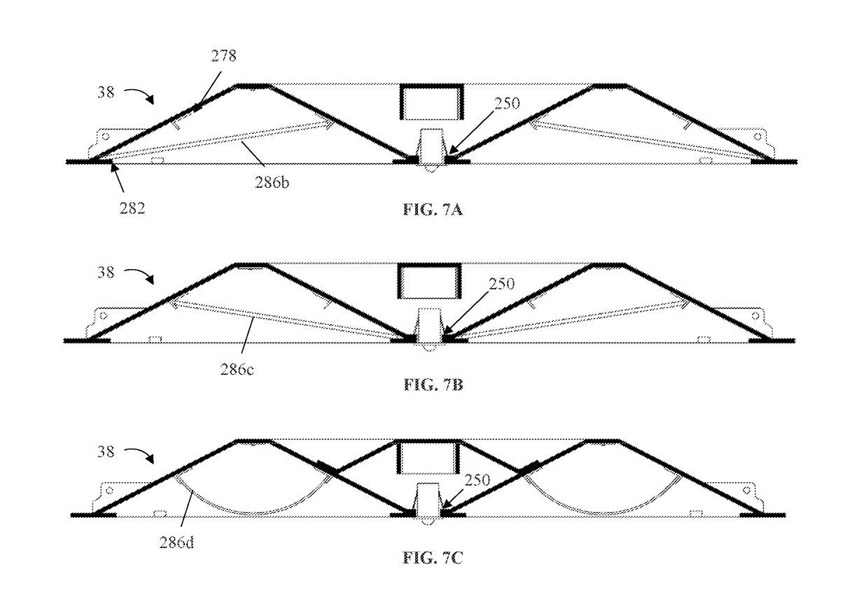

As shown component bridge 270 allows for installation of electrical assemblies without interfering with light output (e.g., electrical assemblies can be installed behind reflector surfaces). In the embodiment shown, component bridge 270 is spaced apart from the portions of the frame having reflector surfaces (e.g., sides 242) such that airflow is permitted between the component bridge and the portions of the frame having reflector surfaces (e.g., to facilitate cooling of and/or prevent over-heating of control components and/or driving components which may be disposed within component bridge 270). However, in other embodiments, space external to and between the upper ends 234 of adjacent inverted channels 130 may be substantially closed (e.g., component bridge 270 can be configured to substantially enclose a volume defined at least in part by sides 242 of inverted channels 230 opposite the reflector surfaces) (e.g., as shown in FIG. 7C). In some embodiments (e.g., in new fixtures, for example, rather than retrofit fixtures) component bridge 270 can substantially enclose sensor bay 246 (e.g., by spanning the distance between upper ends 234 of respective inner channels 230), which can provide the function of an enclosed containment troffer that can contain many, if not all, of the electrical components of the fixtures (e.g., and can be installed as a new fixture).

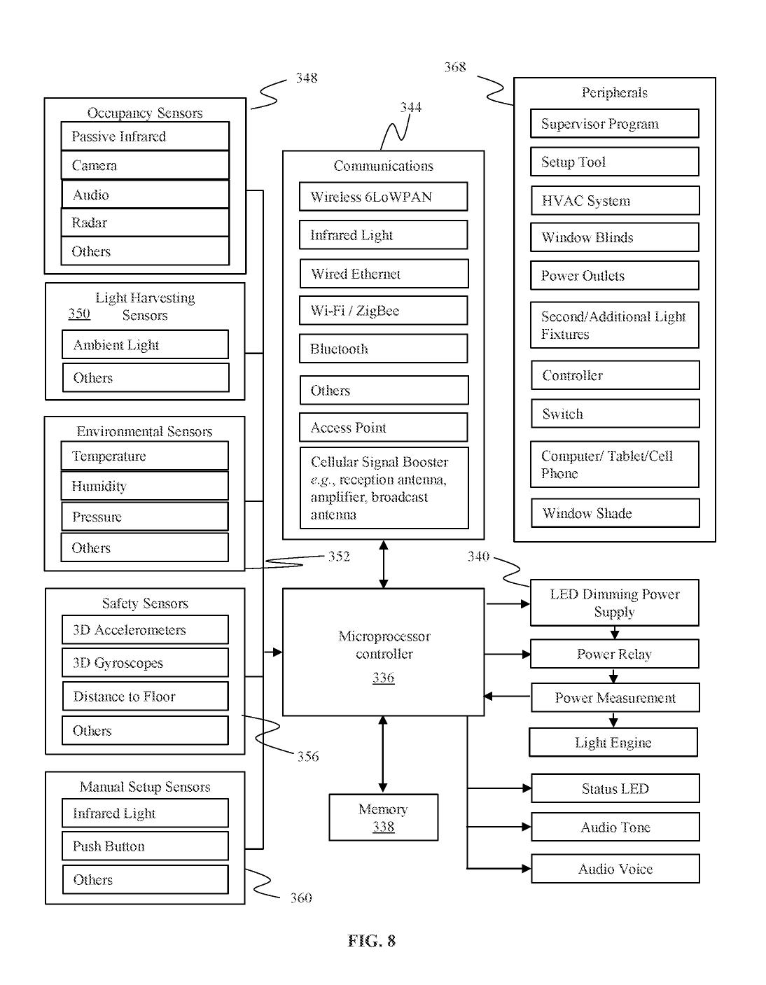

In the embodiment shown, frame 38 further comprises a plurality of lens tabs 278 (e.g., coupled to frame 38) that extend into inverted channel(s) 230 from first and second sides 242, and one or more shelves 282 (e.g., coupled to frame 38) that extend inward towards a vertical plane bisecting an inverted channel 230 from a point that is at lower end 238 or between the lower end and the plurality of lens tabs 278 (e.g., as shown). Lens tabs 278 and/or shelves 282 are configured to support a lens (e.g., a diffusing lens) in a variety of positions, for example, and not by way of limitation, between any of: the one or more shelves independent of the lens tabs (e.g., to support flat lens 286a, as shown in FIG. 7B); one or more of the lens tabs and the one or more shelves (e.g., to support sloped lenses 286b and 286c, as shown in FIGS. 8A and 8B, respectively); or the plurality of lens tabs independent of the one or more shelves (e.g., to support curved (e.g., convex) lens 286d, as shown in FIG. 7C). Lens shapes are shown by way of example, and not limitation, and the present fixtures can be configured to support a variety of lenses (e.g., “V-shaped” lenses). As shown in the above examples, frame 38 can be configured to be coupled to a plurality of lenses (e.g., 286a, 286b, 286c, and/or 286d) such that each lens encloses at least a portion of a different one of the inverted channel (e.g., as shown) and none of the lenses cover mounting location 250 (e.g., such that any sensor(s) 254 are not blocked by the lenses when the lenses are installed into frame 38).

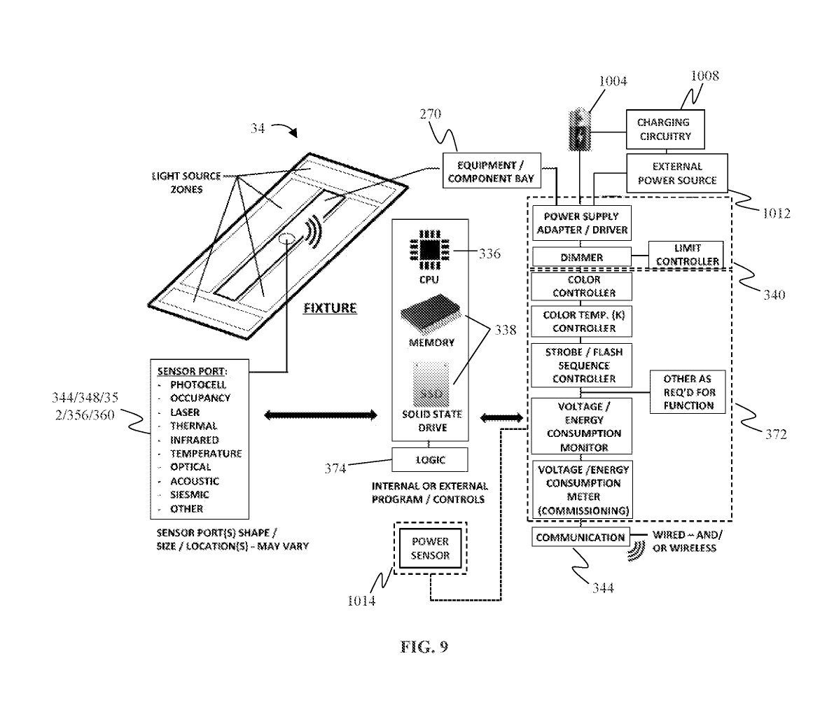

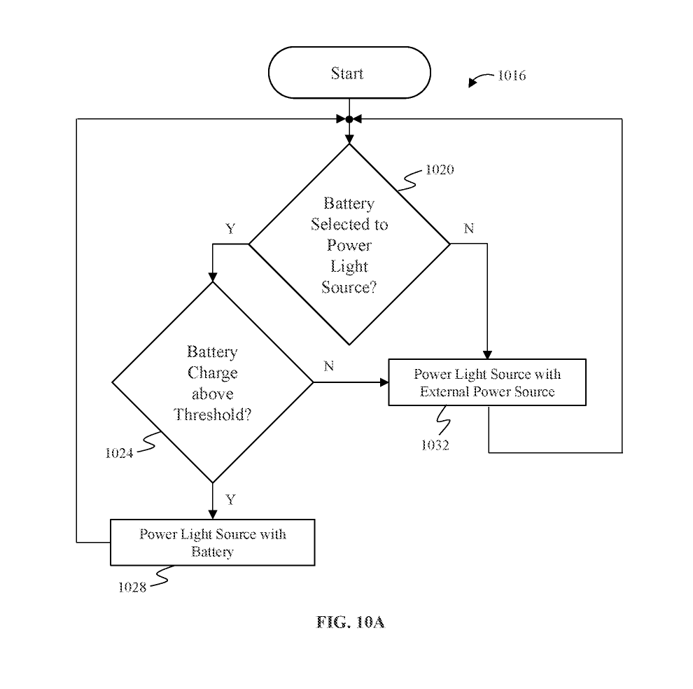

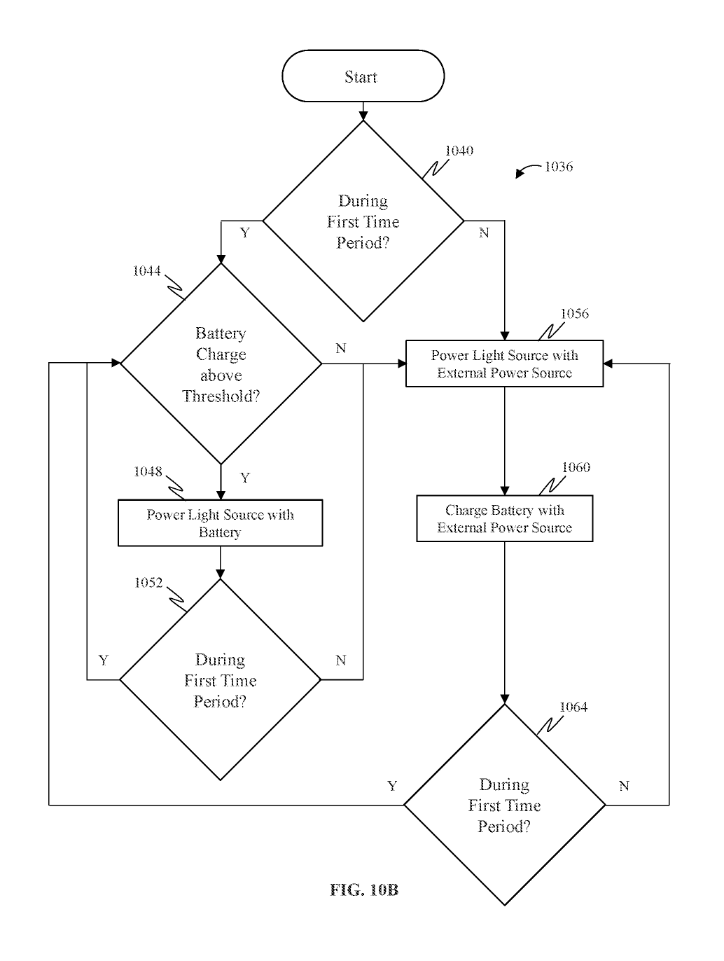

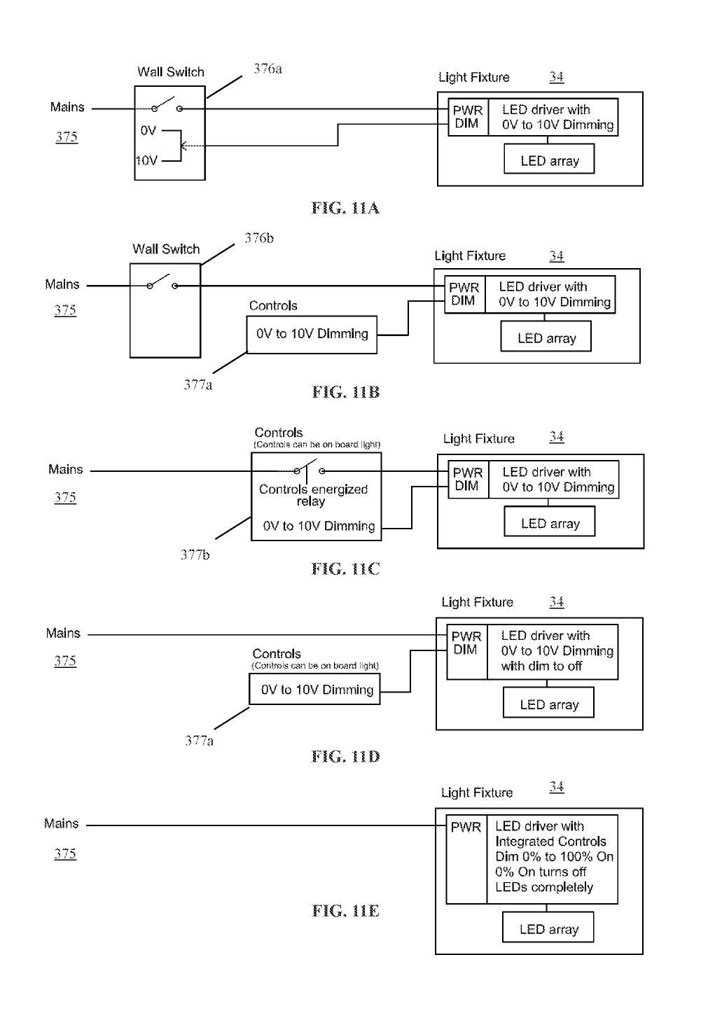

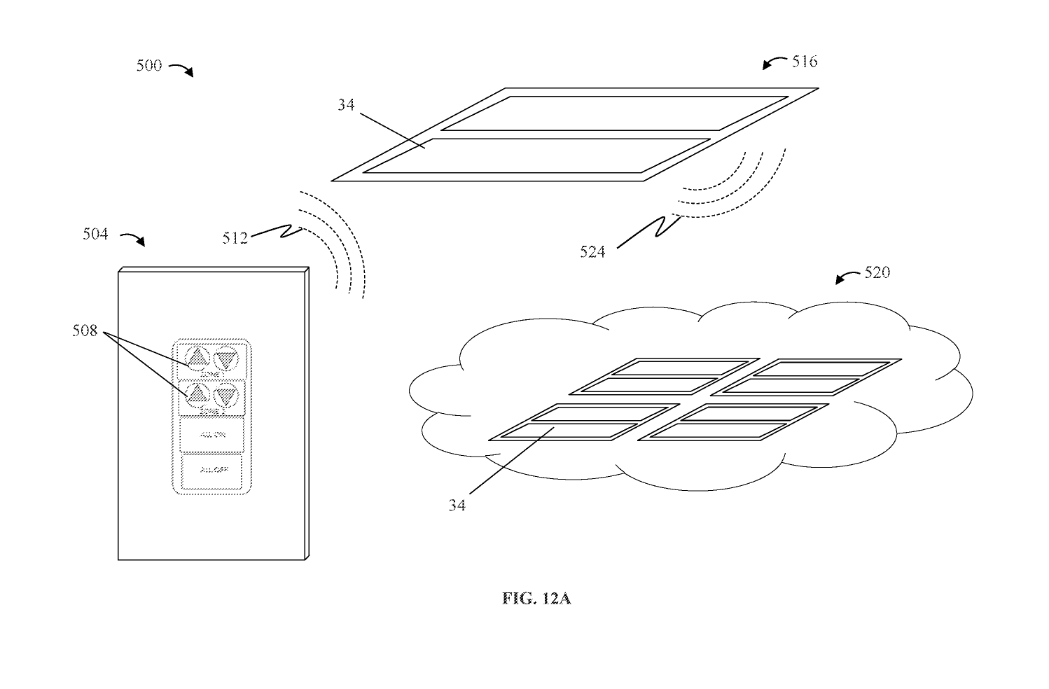

FIG. 8 is a block diagram depicting certain components of some embodiments of the present fixtures (e.g., 34). FIG. 9 is a conceptual diagram depicting some components of FIG. 8. In the embodiment shown, fixture 34 further comprises a processor 336 (e.g., a microprocessor) coupled (e.g., configured to be in electrical communication with) the plurality of LEDs, and configured to control the operation of the LEDs (e.g., at least through operation of at least LED dimming power supply 340). Further control over the LEDs can be provided by LED control components 372 (e.g., as shown in FIG. 9), including controllers (e.g., color, temperature, strobe/flash sequence, and/or the like controllers), and voltage/energy consumption monitors and/or meters. Any number of LED control components 372 may be separate components, or be unitary with processor 336. In some embodiments, the present fixtures further comprise a memory 338 (e.g., random access memory (RAM), flash memory, and one or more hard disk drives, and/or solid state drives, and/or the like). In these embodiments, pre-set features and/or functions can be programmed and stored into memory 338 (e.g., as logic 374, for example, comprising processor executable computer instructions and/or pre-defined variable values, described in more detail below). In some embodiments (e.g., 34), the present fixtures further comprise one or more sensors coupled to processor 336 configured to detect one or more events and/or environmental characteristics. For example, suitable sensors may comprise occupancy sensors 348, light (e.g., light harvesting) sensors 350, such as photocells or ambient light sensors, environmental sensors 352, safety sensors 356, manual setup sensors 360, metering/monitoring sensors (e.g., for commissioning, performance monitoring, lumen maintenance, data collection, analysis, reporting, and/or the like, and/or the like), which may form part of a “Metering/Monitoring kit” for and/or included with the present fixtures, and/or the like.

In the embodiment shown, fixture 34 comprises a rechargeable battery 1004 (e.g., which may be coupled to frame 38), such as, for example, a nickel cadmium, nickel metal hydride, lithium-ion, lead-acid, and/or the like battery. In this embodiment, fixture 34 comprises charging circuitry 1008 (e.g., a battery charger such as a trickle charger), which may also be coupled to frame 38, configured to selectively charge battery 1004 with power from an external power source 1012 (e.g., line power). In some embodiments, a power meter 1014 is coupled to fixture 34 via power supply 340 and/or LED control components 372. Power meter 1014 may include a power sensor configured to measure an amount of power consumed by fixture 34 at any point in time. The power sensor may be coupled to an electrical loop different from power supply 340 and LED control components 372 in order to limit feedback and variations, such as variations in temperature, which may compromise the accuracy and/or precision of the measurements of the power sensor. In some embodiments, the power sensor is an industrial grade sensor with a 24 bit energy measurement processor providing an accuracy of True RMS calculations for current, voltage, line frequency, real power, reactive power, apparent power and power factor. The power sensor may be configured to automatically compensate for ambient temperature tolerances, offsets, and EMI filters. The power sensor provides an accurate method to determine power saving and may be used during constant diagnostics to verify the correct operation of fixture 34. The power sensor may be configured to automatically disconnect the load from battery 1004 and/or power source 1012 if the power sensor detects dangerous voltage levels that exceed design constraints.

In the depicted embodiment, processor 336 is configured to selectively power a light source of fixture 34 with either of battery 1004 or external power source 1012, and such selection may be based on a user command, logic 374, and/or the like. Of course, in some instances, processor 336 does not power the light source, such as when the light fixture is turned off.

For example, in the embodiment shown, processor 336 is configured (e.g., through logic 374) such that, if the processor is powering the light source with battery 1004, the processor will switch to powering the light source with external power source 1012 if necessary to prevent the battery charge from falling below a threshold level. Such a threshold level of battery 1004 charge may be set to ensure compliance with codes associated with battery back-up systems. For example, some codes may require a minimum level of charge in a battery back-up system sufficient to power one or more light sources for a pre-determined period of time (e.g., 1, 1.5, 2, 3 or more hours. Therefore, in fixture 34, a threshold level of battery 1004 charge may be a percentage of a minimum level of battery charge necessary to power the light source of the fixture for a predetermined period of time (e.g., 100, 105, 110, 115, 120, 125, 130, 135, 140, 145, 150, 160, 170, 180, 190, 200 or more percent of the minimum level of battery charge).

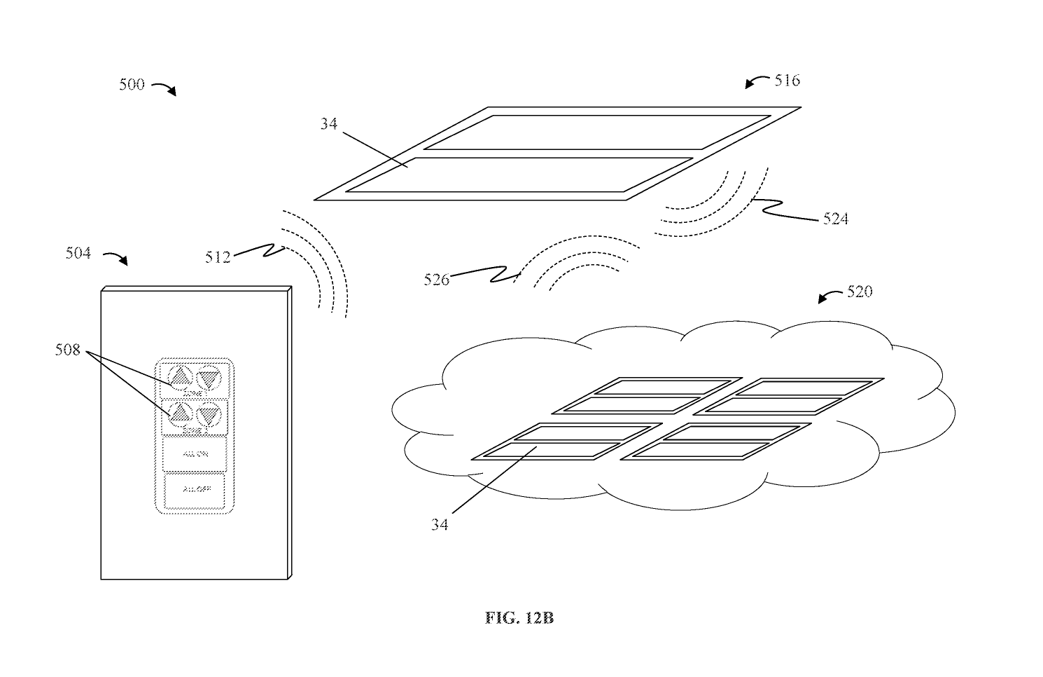

To illustrate, and referring additionally to FIG. 10A, depicted is a flow diagram of one embodiment 1016 of the present methods, which may be implemented by a processor (e.g., 336) of a fixture (e.g., 34) (e.g., as logic 374). For example, in the embodiment shown, at step 1020, the processor may select either of a battery (e.g., 1004) or an external power source (e.g., 1012) to power the light source of the light fixture (e.g., and such selection may be based on user command, logic 374, and/or the like). In this embodiment, if the battery is selected to power the light source, at step 1024, the processor may determine whether the battery charge is above a threshold level (e.g., as described above). In the depicted embodiment, if the battery charge is above the threshold level, at step 1028, the processor may power the light source with the battery. However, if at step 1020, the battery is not selected to power the light source, or, at step 1024, the battery charge is not above the threshold level, at step 1032, the processor may power the light source with an external power source (e.g., 1012).

As discussed above, in the embodiment shown, processor 336 may be configured to select a power source for the light source (e.g., one of battery 1004 or external power source 1012) based on logic 374. For example, in this embodiment, processor 336 is configured to power the light source with battery 1004 during a first time period (e.g., while not allowing the battery charge to fall below a threshold level), and power the light source with external power source 1012 during a second time period (e.g., or during the first time period when battery charge is at or below the threshold level). In the depicted embodiment, processor 336, when not powering the light source with battery 1004, such as during the second time period or when the battery charge is at or below the threshold level, may be configured to charge (e.g., trickle charge) the battery with external power source 1012 through charging circuitry 1008. In some embodiments (e.g., 34), the first time period may occur when energy costs are increased, such as an on-peak electricity time period, and the second period may occur when energy costs are reduced, such as an off-peak electricity time period. In this way, light fixture 34, and more particularly, processor 336, may be configured to reduce energy costs associated with powering the light source, for example, by minimizing the use of external power source 1012 during on-peak electricity time periods.

To illustrate, and referring additionally to FIG. 10B, depicted is a flow diagram of one embodiment 1036 of the present methods, which may be implemented by a processor (e.g., 336) of a fixture (e.g., 34) (e.g., as logic 374). For example, in the embodiment shown, at step 1040, the processor may determine whether the current time is during a first time period (e.g., during which electricity costs are increased, such as an on-peak electricity time period). In this embodiment, at step 1044, the processor may determine whether the battery charge is above a threshold level (e.g., as described above). In the depicted embodiment, if the current time is during the first time period and the battery charge is above the threshold level, at step 1048, the processor may power the light source with the battery. In the embodiment shown, at step 1052, the processor may determine whether the current time is within the first time period, and steps 1044, 1048, and 1052 may be repeated to continue powering the light source with the battery until either: (1) the battery charge falls below the threshold level; (2) the current time is outside of the first time period; or (3) user, other logic, and/or the like intervention acts to halt or alter method 1036.

In this embodiment, if, at steps 1040 or 1052, the current time is outside of the first time period (e.g., is during a second time period, for example, during which electricity costs are reduced, such as an off-peak electricity time period), or, at step 1044, the battery charge is at or below the threshold level, at step 1056, the processor may power the light source with an external power source (e.g., 1012). In the depicted embodiment, at step 1060, the processor may charge the battery with the external power source through charging circuitry (e.g., 1008). In the embodiment shown, at step 1064, the processor may determine whether the current time is within the first time period, and steps 1056, 1060, and 1064 may be repeated to continue powering the light source with the external power source until: (1) the current time is during the first time period; and (2) the battery charge is above the threshold level; or (3) user, other logic, and/or the like intervention acts to halt or alter method 1036.

In the embodiment shown in FIG. 8, fixture 34 comprises one or more communications device(s) 344, which may be coupled to frame 38, for example, disposed within component bridge 270. In this embodiment, one or more communications device(s) 344 may be configured to communicate with various peripherals 368 (e.g., as part of a “smart” network). Suitable communications protocols include, but are not limited to, Wi-Fi, infrared, ZigBee, Bluetooth, Bluetooth Low Energy (BLE), constrained application protocol (CoAP), satellite protocols, local area network (LAN), wide area network (WAN), radio, cellular, communications protocols that are later developed, and/or the like, and such communications protocols, where appropriate, may operate at any suitable frequency (e.g., 900 megahertz (MHz), 2.4 gigahertz (GHz), 5.8 GHz, and/or the like). As will be described in more detail below, such communications can be secured (e.g., encrypted, for example, by processor 336) to prevent unauthorized control of the present fixtures. In the embodiment shown, peripherals 368 can include a variety of components, including, but not limited to, supervisor program(s) (e.g., running via processor 336 and/or other external, to the light fixture, processor(s)), setup tools, heating ventilation, and air conditioning (HVAC) systems (e.g., HVAC damper or other controller), window blinds and/or shades (e.g., controlled by one or more relays), power (e.g., electrical) outlets, second and/or additional light fixtures and/or groups and/or subgroups of light fixtures, controllers, switches, laser pointers, user-operated (or otherwise) devices such as computers, tablets, cell phones or similar mobile devices, and/or the like.

In some embodiments, communication device 344, such as a Bluetooth Low Energy (BLE) device, is configured to communicate with and track objects, such as BLE-enabled peripherals 368, in an environment. For example, a BLE-enabled peripheral 368, such as a computer and/or a mobile device, may be configured to communicate with the BLE device when the peripheral 368 enters and/or exits a room (i.e., “Asset Tracking”). In some embodiments, a plurality of BLE devices in a plurality of rooms may be configured to identify in which of the plurality of rooms the peripheral 368 is located. For example, peripheral 386, such as a BLE-enabled device configured to receive text and/or voice messages (e.g., “messaging device”), may be configured to communicate with the BLE device. The peripheral 368 may be provided to a person, thereby tracking the person and allowing messages to be sent to the person via the messaging device (i.e., “Employee Tracking”). The messages may include instructions for the person, such as instructions to go to a specific room and/or instructions to go to a specific location in a room. In some embodiments, a BLE-enabled asset may trigger an alarm when the asset moves outside of a defined area. In response, the BLE device may text, email, and/or call select BLE-enabled messaging devices to secure the asset.

In embodiments comprising communications device(s) 344, such as fixture 34, remotes (e.g., which may form part of a “programming kit” for and/or included with some of the present fixtures) can be provided to allow a user to control the light source (e.g., LEDs) directly, for example, a user can communicate a command to processor 336 (e.g., to adjust the lighting in the environment, for example, when performing a task requiring a higher or lower level of lighting or when entering or exiting the environment) (e.g., an infrared, Wi-Fi, laser, Bluetooth, Bluetooth Low Energy, and/or the like signal), and processor 336 can communicate the command (and/or ignore and/or modify the command based on characteristics detected by sensors) to LED dimming power supply 340 to effectuate changes in lighting. Such user control functionality can be accomplished in separate and/or additional ways, some of which are described below, for example, through user commands sent over Wi-Fi, or through laser-based remotes. Some embodiments are configured to communicate in a wired fashion (e.g., alone or in addition to wirelessly), for example, through Ethernet cables.

In the embodiment shown, a communications device 344 of a light fixture 34 may be configured to respond to audible signals (e.g., received by the fixture via one or more sensors, described in more detail below, such as, for example, a microphone). Such audible signals can include, but are not limited to, user-generated signals (e.g., voice commands (“lights on,” “lights off,” “dim lights 10%,” “dim lights 90%,” “exam lighting,” “day lighting,” “evening lighting,” and/or the like, including natural language commands, such as, for example, “turn the lights on,” “turn the light off,” “dim the lights,” “increase the lighting,” and/or the like), finger snaps, and/or the like), machine-generated signals (e.g., alarms, beeps, and/or the like), and/or the like. In this embodiment, such audible signals may each be associated with one or more commands (e.g., fixture on, fixture off, a fixture dim level, and/or the like), such that a processor 336 of the fixture may execute one or more commands associated with an audible signal, when the audible signal is received (e.g., and recognized) by a communications device 344 and/or the processor of the light fixture. In some embodiments, a communications device (e.g., 344) and/or a processor (e.g., 336) of a fixture (e.g., 34) may be configured to disregard audible signals from unauthorized and/or unverified sources and/or users (e.g., by implementing speak-recognition functionality, second level security protocols, as described in more detail below, and/or the like). Of course, in the depicted embodiment, fixture 34 may be configured to communicate a command, via a communications device 344, and/or command, via a processor 336, other light fixtures in response to receiving an audible signal associated with one or more commands (e.g., such that a group of fixtures may each react to an audible signal received by a single fixture).

In the embodiment shown, a communications device 344 of fixture 34 comprises an access point configured to allow devices, such as user devices (e.g., cellular phones, tablets, personal computers, laptops, and/or the like) within range of the access point, to connect to a wireless network (e.g., such that the access point creates a wireless hotspot in the vicinity of the access point). For example, in this embodiment, the wireless access point is configured to connect to a wired or wireless network and to permit a user to wirelessly access the network via the access point. In the depicted embodiment, the access point, though allowing wireless access to a network, does not necessarily allow devices connected to the network through the access point to control lighting components, such as the fixture, other fixture(s), and/or the like (e.g., the access point may be configured to wirelessly connect devices to a network that is separate from a network through which commands are transmitted to the lighting components). Such access points (and associated network(s)) may provide for communication via any suitable communications protocol, including the communications protocols described above. In some embodiments, a communications device (e.g., 344) of a fixture (e.g., 34) may comprise any suitable networking component(s), such as, for example, a repeater, a wireless range extender, a bridge, and/or the like. In these ways and others, fixture 34, and more particularly, a communications device 344 thereof, may provide for enhanced wireless network access, enhanced wireless network signal strength, and/or the like within a space or building.

In the embodiment shown, a communications device 344 of fixture 34 comprises a signal booster, such as a cellular repeater. For example, in this embodiment, a communications device 344 of fixture 34 comprises a reception antenna configured to receive a cellular signal, an amplifier configured to increase the power of the cellular signal to produce an increased power cellular signal, and a broadcast antenna configured to broadcast the increased power cellular signal. In this way, fixture 34, and more particularly, a communications device 344 thereof, may provide for enhanced cell phone reception within a space or building.

In this embodiment, a communications device 344 of fixture 34 may be configured to detect the presence of and/or identify a user device. For example, in the depicted embodiment, a communications device 344 comprises a receiver or transceiver configured to detect the presence of a user device and determine an identifier associated with the user device. For example, in the embodiment shown, a communications device 344 comprises a Bluetooth radio configured to detect the presence of a user device and determine a media access control (MAC) address, name, and/or other identifier associated with the user device. However, in other embodiments, a communications device (e.g., 344) may comprise any suitable receiver or transceiver for accomplishing such detecting and identifying functionality, such as, for example, a radio-frequency identification (RFID) reader, and/or the like.

In this embodiment, processor 336 may be configured to control one or more light fixtures based on an identified user device. For example, in the depicted embodiment, processor 336 is configured to control, based at least in part on one or more settings associated with an identified user device, the light source of fixture 34 to vary a lighting condition. Such settings associated with a user device may include, for example, light source on, light source off, a light source dimming level, and/or the like. In the embodiment shown, a communications device 344 of fixture 34 may communicate with other fixture(s) when the communications device identifies a user device, and/or processor 336 of the fixture may control light source(s) of the other fixture(s) based, at least in part, on one or more setting associated with the identified user device, such that, for example, identification of a user device by a single fixture may result in (e.g., uniform) operation of a group of fixtures. In these ways and others, for example, a user having (e.g., carrying) an identifiable user device may walk into a room or space, and fixtures 34 within the room or space may automatically produce a lighting condition based on one or more settings associated with the user device, without a need for the user to physically activate any switches or controls (e.g., which may be particularly desirable in spaces or rooms where germ or contamination control is important, such as, for example, in a hospital).

In some embodiments, identification of a user device may impact other functionality of a fixture (e.g., 34) (or fixture(s) in communication with the fixture). For example, in some embodiments, a fixture (e.g., 34), and more particularly, a communications device (e.g., 344) and/or a processor (e.g., 336) of the fixture, may be configured to accept certain voice commands from a user (e.g., via speech recognition functionality) only upon identification of a user device associated with the user (e.g., thereby providing a second level security protocol). For further example, in some embodiments, one or more light fixture function(s) (e.g., configuration, set up, initialization, and/or the like function(s)) may only be operable upon identification of a specified user device (e.g., such as a device of an authorized maintenance and/or installation technician, a configuration, set up, initialization, and/or the like device (e.g., that may function as a key), and/or the like).

For example, some embodiments of the present methods, which may be implemented by a processor (e.g., 336) of a fixture (e.g., 34) (e.g., as logic 374), comprise detecting a presence of a user device with a communications device (e.g., 344) coupled to a frame (e.g., 38) of a light fixture (e.g., 34) having a light source, determining an identifier associated with the user device, and controlling the light source to vary a lighting condition, based at least in part on or more settings associated with the identifier. Some embodiments comprise controlling a light source of at least one other fixture to vary a lighting condition, based at least in part on the one or more settings associated with the identifier.

FIGS. 11A-11E are block diagrams depicting various embodiments of the present switches and/or controllers (e.g., 34). These examples are provided only by way of illustration and not by way of limitation. As shown, the present fixtures (e.g., 34) can be configured to be in electrical communication with a conventional wall switch (e.g., 376a and/or 376b) that is in electrical communication with mains 375 (e.g., FIGS. 11A and 11B). Conventional wall switches can include on and off switches, dimmers, and/or the like (e.g., as shown). In embodiments configured to work with wall switches that may not comprise dimmers (e.g., FIG. 11B), dimming can be controlled through a controller (e.g., 377a, which may be on board light fixture, for example, processor 336, and/or external to the light fixture, a server and/or a different light fixture operating in a “master” configuration). In some embodiments, a wall switch need not be present, and a controller (e.g., 377b) can perform on and off operations, dimming, and/or the like (e.g., FIG. 11C). The present fixtures can also be configured to work with a controller (e.g., 377a) with substantially only dimming control (e.g., 14D). In such fixtures, the light fixture may treat dimming commands from controller 377b additionally as an on and off command (e.g., in a dim to off fashion, if, for example, controller 377b sends a dimming signal at or near 0 V). In some embodiments, dimming commands sent to one fixture (e.g., 34) may be relayed (via a wired and/or wireless connection) to other fixture(s) (e.g., via a communications device 344 of the fixture, a processor 336 of the fixture, and/or the like).

Referring now to FIG. 12A, shown is one embodiment 500 of the present systems, which may be suitable for use with some embodiment of the present fixtures (e.g., 34). In the embodiment shown, system 500 comprises a kinetic switch 504 configured to receive a physical user input and to convert the physical user input, using a power associated with the physical user input, into an electrical signal indicative of the physical user input (e.g., by using kinetic energy associated with the physical user input, such that the kinetic switch need not receive power from any other source in order to operate). As shown, kinetic switch 504 includes one or more user input devices 508 (e.g., buttons, knobs, switches, sliders, and/or the like), each corresponding to a desired lighting condition (e.g., on, more bright, less bright (e.g., dim), off, and/or the like). In this embodiment, kinetic switch 504 may be configured such that user actuation of each of one or more user input devices 508 causes the kinetic switch to communicate a respective electrical signal 512 indicative of the desired lighting condition corresponding to the user input device.

In the depicted embodiment, system 500 includes a plurality of light fixtures 34. In the embodiment shown, one of light fixtures 34 may be designated as a master light fixture 516, and the remaining light fixtures may function as slave light fixtures 520 (e.g., under control of the master light fixture). In this embodiment, master light fixture 516 is the closest in physical proximity of fixtures 34 to kinetic switch 504 (e.g., to minimize losses in signals transmitted between the kinetic switch and the master light fixture); however, in other embodiments, any suitable one of light fixtures (e.g., 34) may be designated as a master light fixture (e.g., 516) and/or any suitable one of the light fixtures may be designated as a slave light fixture (e.g., 520).

In the depicted embodiment, master light fixture 516 includes a communications device 344 configured to receive a first electrical signal 512 indicative of a desired lighting condition from kinetic switch 504, and communicate a second electrical signal 524 indicative of the desired lighting condition to at least one slave light fixture 520. In the embodiment shown, a communications device 344 of master light fixture 516 is configured to receive first electrical signal 512 and transmit second electrical signal 524 wirelessly; however, in other embodiments, a communications device (e.g., 344) of a master light fixture (e.g., 516) may be configured to receive a first electrical signal (e.g., 512) and/or transmit a second electrical signal (e.g., 524) over a wired connection. In this embodiment, first electrical signal 512 may be transmitted over a first communications protocol and/or frequency (e.g., 900 MHz, 2.4 GHz, 5.8 GHz, and/or the like), second electrical signal 524 may be transmitted over a second, different communications protocol and/or frequency (e.g., 900 MHz, 2.4 GHz, 5.8 GHz, and/or the like), and one or more slave light fixtures 520 (e.g., or respective communications devices 344 thereof) may be configured to communicate over the second communications protocol or frequency (e.g., to prevent interferences between the first and second electrical signals, to prevent one or more slave light fixtures 520 from undesirably and/or inconsistently responding to first electrical signal 512, and/or the like).

In the depicted embodiment, light fixtures 34 may be configured to produce a desired lighting condition in a uniform or substantially uniform fashion in response to a first electrical signal 512 indicative of the desired lighting condition received by master light fixture 516. For example, in the embodiment shown, a second electrical signal 524 indicative of a desired lighting condition transmitted to one or more slave light fixtures 520 by master light fixture 516 may include a temporal component indicative of a time upon which to produce the desired lighting condition. To illustrate, in this embodiment, master light fixture 516 may receive a first electrical signal 512 from kinetic switch 504 indicative of a desired lighting condition, set a specified time upon which to produce the desired lighting condition (e.g., with the master light fixture and one or more slave light fixtures 520), and communicate a second electrical signal 524 indicative of both the desired lighting condition and the specified time upon which to produce the desired lighting condition to the one or more slave light fixtures. In this way, each of light fixtures 34 may be operated in a substantially simultaneous fashion to produce a desired lighting condition in response to user actuation of kinetic switch 504 (e.g., thus avoiding delayed operation of one or more of the fixtures that may otherwise be caused by a lag in electrical signal processing and/or transmission).

Some embodiments of the present methods comprise receiving, with a master light fixture (e.g., 516) and from a kinetic switch (e.g., 504), a first electrical signal (e.g., 512) indicative of a desired lighting condition, the kinetic switch configured to receive a physical user input and convert the physical user input, using a power associated with the physical user input, into an electrical signal indicative of the physical user input, communicating, from the master light fixture and to at least one slave light fixture (e.g., 520) a second electrical signal (e.g., 524) indicative of the desired lighting condition, activating the master light fixture, based at least in part on the first electrical signal, and activating the at least one slave light fixture, based at least in part on the second electrical signal. Some methods comprise delaying activation of the master light fixture and the at least one slave light fixture until a specified time such that the master light fixture and the at least one slave light fixture are each activated substantially simultaneously. In some methods, the second electrical signal includes a temporal component indicative of the specified time.

In some embodiments, master light fixture 516 is configured to synchronize a plurality of slave light fixtures 520 (e.g., inspect for and correct malfunctions). For example, as depicted in FIG. 12B, (e.g., after receiving first electrical signal 512 from kinetic switch 504 indicative of a desired lighting condition), master light fixture 516 may check one or more slave light fixtures 520 for faults via second electrical signal 524. In response, in some embodiments, each of the one or more slave light fixtures 520 transmit a third electrical signal 526 to master light fixture 516. For example, each of slave light fixtures 520 may transmit third electrical signal 526 to confirm that the fixture is online and functioning properly (e.g., with the settings indicated by the master fixture or other controller). Alternatively, third electrical signal 526 may indicate a malfunction or difference in operation or parameters relative to those instructed by the master fixture or other controller. Upon failing to receive third electrical signal 526 from a slave fixture and thus indicating a malfunction (or receiving a third electrical signal 526 indicative of a malfunction), master light fixture 516 may automatically reset and reprogram the respective malfunctioning slave light fixture 520 via a subsequent second electrical signal 524. Thereafter, master light fixture 516 may resend the desired lighting condition via second electrical signal 524 to the one or more slave light fixtures 520.

In some embodiments, dim inputs may be programmed to select one of a plurality of modes. In one example, a “wireless dim input” mode may be used to detect the dim level when used with a 900 MHz wireless kinetic switch. In another example, a “0-10V wired dim input” mode may be used to detect the dim level when used with standard control wires from a 0-10V dimming switch. In yet another example, a “PWM wired input” mode may be used to detect the dim level when used with a PWM dimming input.

In some embodiments (e.g., 34), signals other than operating signals, such as, for example, configuration signals (e.g., signals for changing or storing one or more calibration and/or configuration settings, and/or the like), may be sent to a light driver, such as an LED dimming power supply (e.g., 340), and such operating signals and configuration signals may be sent over a single channel of communication (e.g., minimizing costs associated with distinct channels of communication for operating signals and configuration signals). For example, in the embodiment shown, a processor 336 of fixture 34 is configured to communicate signals, such as pulse width modulated (PWM) signals, each having a duty cycle. In this embodiment, LED dimming power supply 340 (e.g., when in an operating mode, as described below) is configured to receive a signal from processor 366, and, if the duty cycle of the signal is above a threshold duty cycle (e.g., above 1, 2, 3, 4, 5, 6, 7, 8, 9, 10, 15, 20, 25, or more percent), power a light source of the fixture, based at least in part on the signal (e.g., treating the signal as an operating signal). In this embodiment, LED dimming power supply 340 (e.g., when in an operating mode) is configured to, if the duty cycle of the signal is below a threshold duty cycle, allow changes to one or more configuration settings of the LED dimming power supply, which may be stored in a memory associated with the LED dimming power supply (e.g., treating the signal as a trigger or escape signal, thereby entering a configuration mode wherein subsequent signals from the processor may operate to change the one or more configuration settings of the LED dimming power supply).

In this embodiment, LED dimming power supply 340 (e.g., when in a configuration mode) is configured to continue to allow changes to the one or more configuration settings of the LED dimming power supply until the LED dimming power supply receives a subsequent signal from processor 336 having a duty cycle below the threshold duty cycle (e.g., treating the signal as an escape or trigger signal, thereby entering or re-entering an operating mode wherein subsequent signals from the processor are treated as operating signals). In some embodiments, an LED dimming power supply (e.g., 340) of a fixture (e.g., 34) is configured to, when allowing changes to one or more configuration settings of the LED dimming power supply (e.g., when the LED dimming power supply is in a configuration mode), continue powering a light source of the fixture, based at least in part on the last operating signal received from a processor (e.g., 336) (e.g., such that there is little or no perceptible change in a lighting condition provided by the light fixture while the LED dimming power supply is in the configuration mode).

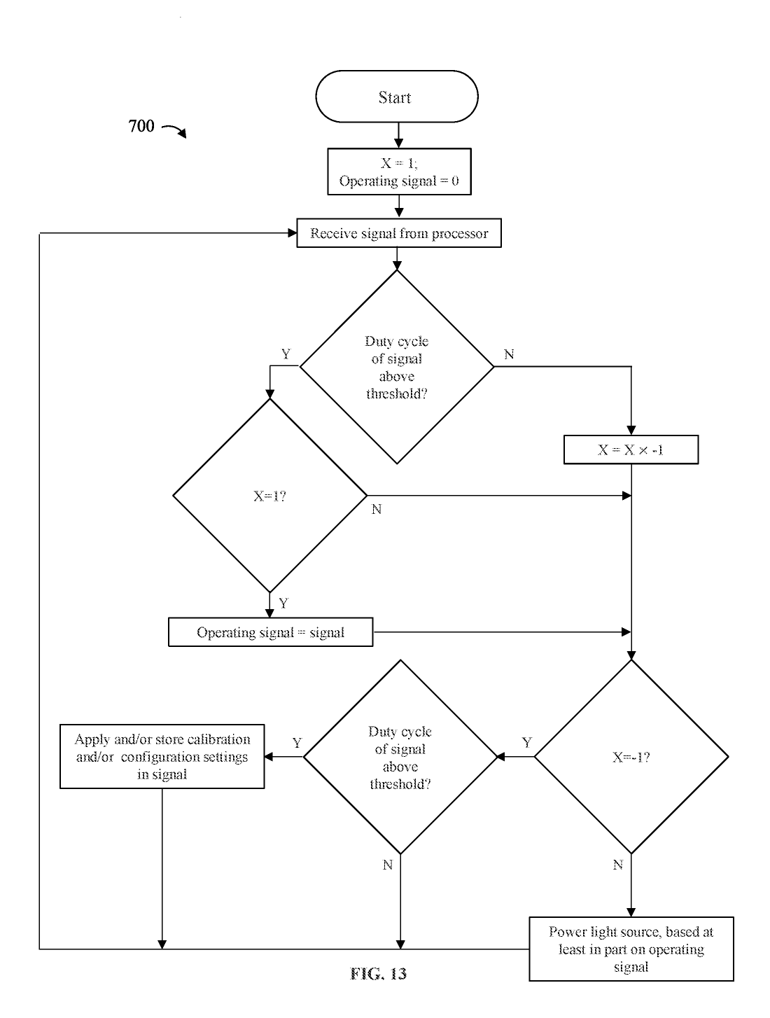

For example, some embodiments of the present methods (e.g., method 700, FIG. 13), which may be implemented by a processor (e.g., 336) of a fixture (e.g., 34) (e.g., as logic 374), comprise communicating one or more signals, each having a duty cycle, to a light driver (e.g., LED dimming power supply 340) (e.g., over a single communications channel), the light driver configured to power a light source (e.g., a light source of the fixture), and the one or more signals including a first signal having a first duty cycle and a second signal subsequent to the first signal and having a second duty cycle, if the first duty cycle is above a threshold duty cycle, powering the light source, based at least in part on at least one of the first signal and the second signal, and, if the first duty cycle is below the threshold duty cycle, allowing changes to one or more configuration settings of the light driver, based at least in part on the second signal.

In embodiments with sensors, the processor can be configured to control operation of the LEDs response to one or more events or environmental characteristics detected by the one or more sensors (e.g., at least by communicating control signals to LED dimming power supply 340 based on detected characteristics). What follows are some examples of features and/or functionalities of some embodiments (e.g., 34) of the present fixtures. The following examples are provided for illustrative purposes only, and do not limit the scope of the present disclosure. The following examples make additional reference to FIG. 15A, which depicts an example of an environment (e.g., an office and/or room) having fixtures of the present disclosure.

Light harvesting sensors 350 (e.g., which may be present on any of light fixtures A through D) (e.g., which may form part of a “Daylighting Kit” for and/or included with some of the present fixtures), such as photocells, can detect ambient light in an environment (e.g., light from sun 380 entering through window 384 and/or light from any other source). Environmental characteristics collected from light harvesting sensors can be used, for example, to control any automated window blinds and/or window shades (e.g., that may be coupled to window 384 to allow natural light in to reduce power consumption of artificial lights) (e.g., a “Window Blind Kit”). For example, ambient lighting conditions near fixture A may be brighter than at fixture B, therefore, fixture A may be set to a lower light output than fixture B, to conserve energy. In some embodiments, light harvesting sensor 350 accurately matches the human eye spectral response and rejects 50 Hz and/or 60 Hz lighting flicker. Light harvesting sensor 350 may include a dynamic range of 0.01 lux to 64k lux. Light harvesting sensor 350 may also be used to detect a laser pointer when used during installation. For further example, if conditions at fixture A are too hot (e.g., due to, for example, solar heat gain, and as indicated, for example, by an environmental sensor 352, such as a temperature sensor, which may be present on any of light fixtures A through D), any window blinds and/or shades on window 384 can be actuated (e.g., by a processor 336, for example, of a “master” fixture, and/or by a separate processor and/or controller, which may be external to the fixtures). Through at least onboard and/or external (e.g., remote) logic, the present fixtures (e.g., fixture) can determine, for example, that energy consumption is lower when the blinds and/or shades are closed (e.g., that additional lighting demands caused by the closure of the blinds and/or shades require less energy than HVAC demands due to solar heat gain and/or the like when the blinds and/or shades are open). Light harvesting sensors in some embodiments can also be used to control fixture output to optimize Circadian rhythm of occupants that may not be exposed to natural lighting.

In some embodiments, light harvesting sensors 350 may include a delay configured to prevent changing light output, window blind, and/or window shade characteristics in reaction to changing environmental characteristics for a predetermined amount of time (i.e., predetermined delay time). For example, ambient light conditions near fixture A may become more dim when sun 380 is temporarily blocked, such as by a cloud. During the predetermined delay time, the delay may be configured to prevent increasing the light output from fixture A in response to the reduced or dimmed ambient light conditions. However, when the ambient light conditions near fixture A remain blocked for a time longer than the predetermined delay time, fixture A may respond to the more dim ambient light conditions by increasing light output. Similarly, for the predetermined delay time, the delay may be used to prevent actuation of the automated window blinds and/or window shades in response to a change in ambient lighting conditions. In some embodiments, the delay is internal and built into each light harvesting sensor 350. The predetermined delay time ranges from 10 seconds to 2 minutes, such as 20 seconds to 1 minute. In some embodiments, the delay may be bypassed in response to a threshold change in ambient light conditions in a predetermined amount of time (i.e., predetermined bypass time). For example, when the change ambient light conditions exceeds 40% to 75%, such as 50% to 60%, within the predetermined bypass time ranging from 1 second to 10 seconds, such as 2 seconds to 5 seconds, the delay may be bypassed. As a result, the light output, window blind, and/or window shade may immediately react to the change in ambient light conditions.

Occupancy sensors 348 can detect motion (e.g., ultrasonic sensors, other motion detectors), thermal energy (e.g., infrared sensors, such as passive infrared (PIR) sensors), sound (e.g., acoustic sensors, such as microphones), images (e.g., digital or other cameras), and/or the like (e.g., and may form part of an “Occupancy Kit” for and/or included with some of the present fixtures). For example, cameras can be configured to detect occupancy by taking a series (e.g., at least two) images of an environment. Processor 336 can then compare the series of images to detect changes in the environment (e.g., changes in occupancy, such as a person entering or leaving the environment) (e.g., by comparing the pixel values, or pixilation, from one image with the pixel values from a second image).

For example, in the embodiment shown, fixture 34 comprises an acoustic sensor configured to capture data indicative of acoustic signals (e.g., sounds) in an environment. In this embodiment, a processor (e.g., a processor 336 of light fixture 34, a processor of another one of the light fixtures, a processor remote from the light fixture(s), and/or the like) is configured to determine if data captured by the acoustic sensor indicates an occupancy in the environment. For example, in the depicted embodiment, the processor is configured to compare (e.g., through spectral analysis functionality, which may be included as logic 374) at least a portion of the data captured by the acoustic sensor with one or more predetermined acoustic signals (e.g., stored in a memory 388) that may be indicative of an occupancy in an environment to determine if the at least a portion of the data captured by the acoustic sensor indicates an occupancy in the environment. Such predetermined acoustic signals may include, for example, keyboard strokes, foot steps, a door or window opening or closing, paper shuffling, and/or the like. In the embodiment shown, the processor may be configured to activate a light source of fixture 34 and/or light source(s) of other fixture(s) if data captured by the acoustic sensor indicates an occupancy in the environment.

Additionally, or alternatively, in some embodiments, at least one acoustic sensor, such as three acoustic sensors, are configured to map objects, including fixtures 34 and peripherals 368, in an environment. For example, the acoustic sensor may include a microphone configured to capture acoustic signals emitted from the objects. Referring now to FIG. 15B, the acoustic sensor, such as a first acoustic sensor 390, may determine a radial distance (e.g., defined by a first radius 392) between first acoustic sensor 390 and a location of the acoustic signal emitted by an object. However, first acoustic sensor 390 may not be able to determine a circumferential position of the acoustic signal on first radius 392. In order to further define the location of the acoustic signal, a second acoustic sensor 394 may be used and configured to map objects in the environment. Second acoustic sensor 394 determines a radial distance (e.g., defined by a second radius 396) between second acoustic sensor 394 and the location of the acoustic signal. As such, the location of the acoustic signal is at an intersection of the circumference formed by first radius 392 and second radius 396 (e.g., either point A or point B). In order to further define the location of the acoustic signal, a third acoustic sensor 398 may be used and configured to map objects in the environment. For example, third acoustic sensor 398 may be used to triangulate the location of the acoustic signal. Third acoustic sensor 398 determines a radial distance (e.g., defined by a third radius 399) between third acoustic sensor 398 and the location of the acoustic signal. As such, the location of the acoustic signal (i.e., the location of the object) is at an intersection of the circumferences formed by first, second, and third radii 392, 396, 399 (e.g., point B). In such embodiments, the mapping of multiple fixtures and peripherals can proceed in a manner similar to those described in this disclosure for mapping with light sources and light sensors.

Additionally, or alternatively, in some embodiments, one or more global positioning (GPS) sensors are configured to map objects, including fixtures 34, in an environment. For example, a GPS receiver, such as a GPS antenna, may be positioned proximate a window. The GPS receiver may be configured to transmit a GPS signal to each of the one or more GPS sensors in the environment. In some embodiments, each fixture 34 includes a respective GPS sensor. As such, the GPS receiver may be configured to determine the position of each fixture 34 (e.g., having the GPS sensor) relative to the GPS receiver.

In the embodiment shown, two or more occupancy sensors 348 may be configured to cooperate with one another and/or with a processor 336 to detect an occupancy in an environment and/or control one or more fixture(s) 34 accordingly. For example, a motion detector of a fixture 34 may detect motion in an environment to activate one or more camera-based sensors (e.g., of the fixture and/or of other fixture(s)), which, through communication with a processor 336, can determine whether the motion detected is a result of a change in occupancy (e.g., cameras may be more accurate for detecting changes in occupancy than motion detectors, but may consume more power; therefore, it may be advantageous, but may not be necessary, for both types of occupancy sensors to work together as part of a system).

For further example, in the embodiment shown, fixture 34 comprises an optical sensor (e.g., a PIR sensor or camera, as described above) configured to capture data indicative of objects, such as fixtures 34 and/or peripherals 368, in the environment, and the processor is configured to activate the light source of the fixture and/or light source(s) of other fixture(s) if the data captured by the optical sensor indicates an occupancy in the environment. In this embodiment, the processor is configured to deactivate the light source of fixture 34 or the light source(s) of the other fixture(s) if neither the data captured by the optical sensor nor the data captured by the acoustic sensor indicates an occupancy in the environment (e.g., avoiding prematurely deactivating the fixture(s), for example, when the environment may still be occupied).

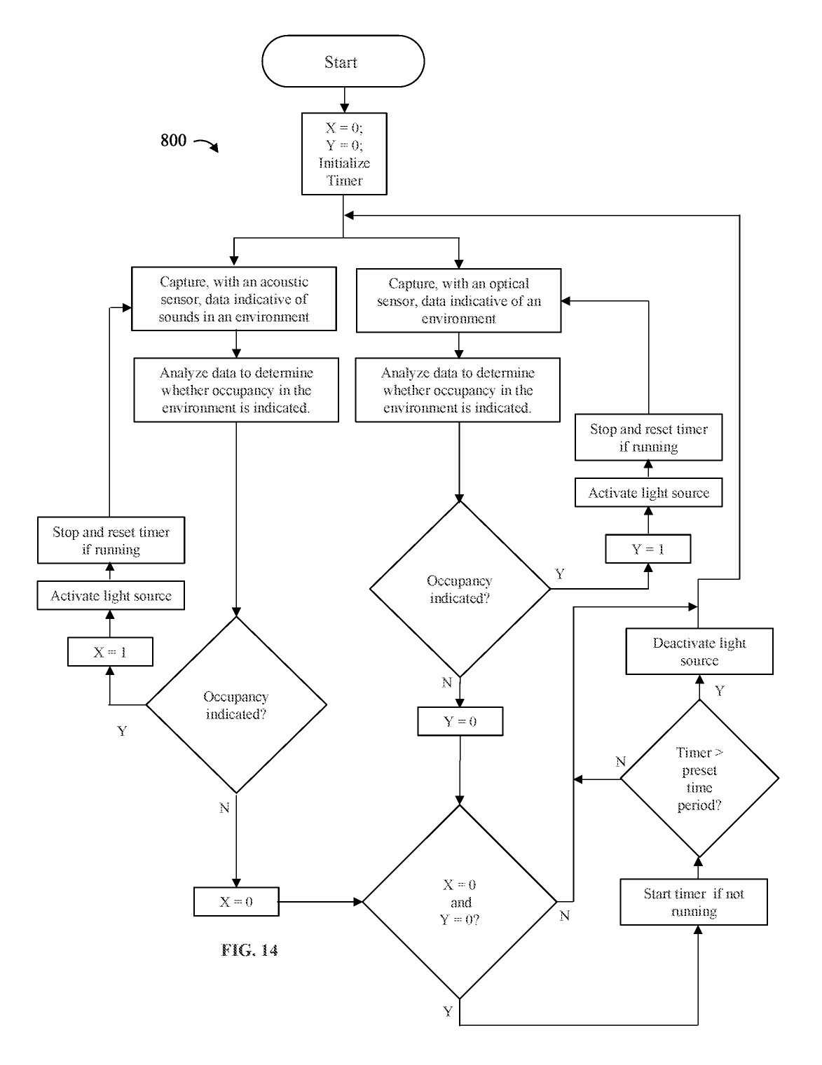

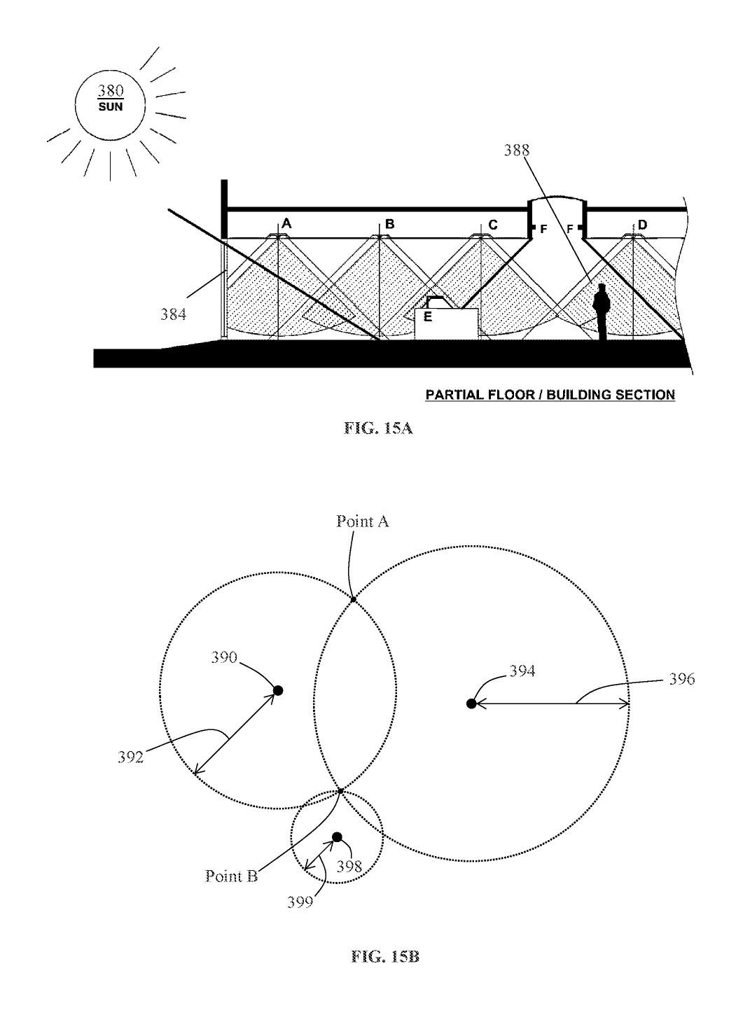

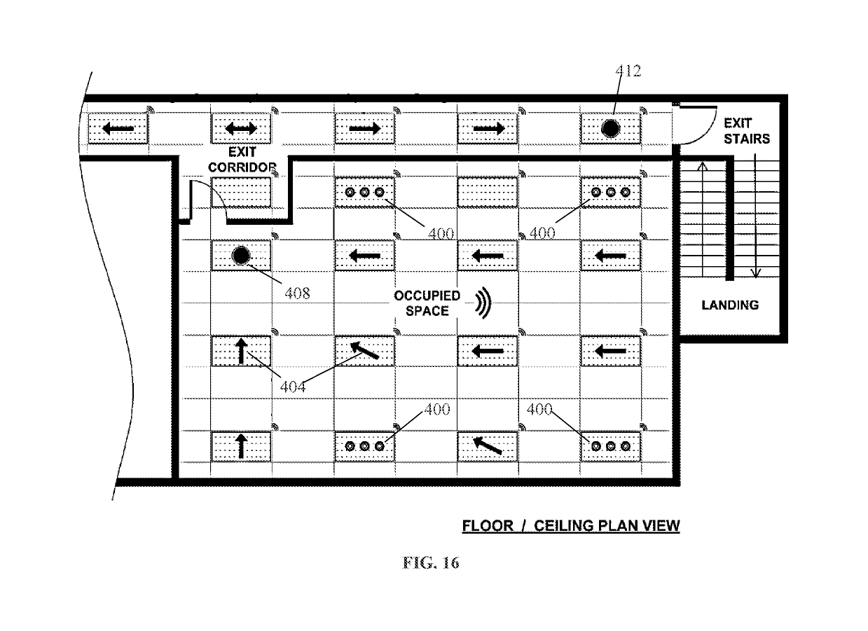

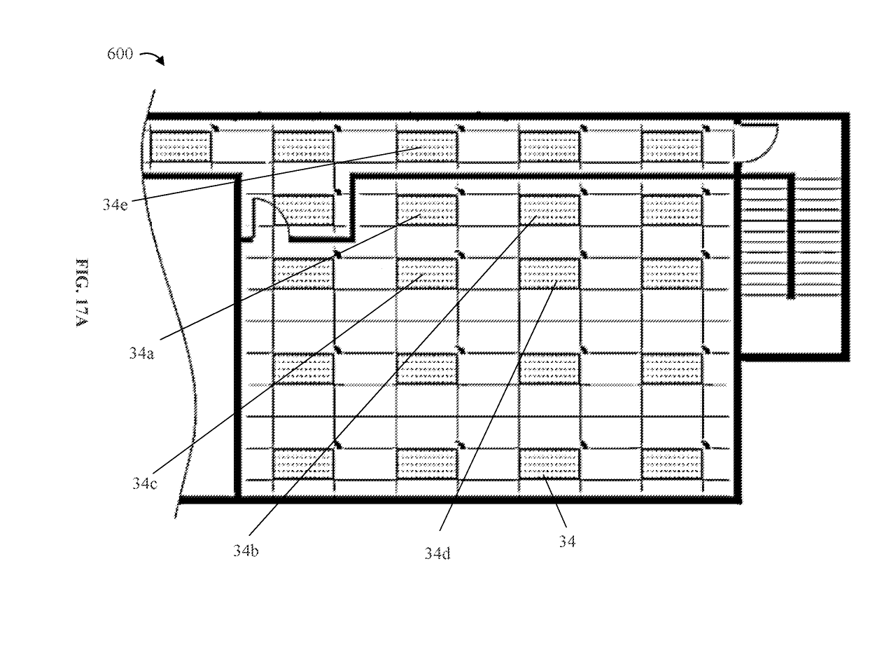

For example, some embodiments of the present methods (e.g., method 800, FIG. 14), which may be implemented by a processor (e.g., 336) of a fixture (e.g., 34) (e.g., as logic 374), comprise capturing, with an acoustic sensor, data indicative of acoustic signals (e.g., sounds) in an environment, determining whether at least a portion of the data captured by the acoustic sensor is indicative of an occupancy in the environment, capturing with an optical sensor, data indicative of objects in the environment, activating the light source if the at least a portion of the data captured by the acoustic sensor or the data captured by the optical sensor indicates an occupancy in the environment, and deactivating the light source if neither the at least a portion of the data captured by the acoustic sensor nor the data captured by the optical sensor indicates an occupancy in the environment. In some embodiments, determining whether at least a portion of the data captured by the acoustic sensor is indicative of an occupancy in the environment comprises comparing (e.g., using spectral analysis functionality) at least a portion of the data captured by the acoustic sensor with one or more predetermined acoustic signals indicative of an occupancy in the environment.

Occupancy sensors (e.g., cameras, for example, relatively high resolution cameras, audio sensors, such as microphones, and/or the like) can also be used for security purposes (e.g., to detect an unauthorized individual in an area) (e.g., which may form part of a first level “Security Kit” for and/or included with some of the present fixtures).

Processor 336 can, for example, communicate with at least LED dimming power supply 340 to effectuate the appropriate lighting changes (e.g., if a room is detected as unoccupied, the processor can reduce lighting to conserve energy). Such an occupancy sensor can also be used in the event of an emergency (e.g., earthquake, fire, and/or the like) to communicate (e.g., notify) the logic and/or communication device(s) (e.g., in a wired and/or wireless fashion) to report the location of occupants within an environment to first responders (e.g., through communications device 344). Occupancy sensors may also be used to communicate demands to HVAC systems (e.g., unoccupied rooms may have a lower HVAC demand). Through at least occupancy awareness, facilitated through occupancy sensors 348, the present fixtures can be configured to cooperate with others of the present fixtures (e.g., in a network) to further increase lighting efficiency (e.g., minimize power consumption). For example, and with reference to FIG. 15A, rings of fixtures (e.g., adjacent fixtures surrounding a given fixture) can define proximity perimeters. For example, a first level perimeter can be defined (e.g., identified by a processor 336) by a detected occupant (e.g., 388) within range of the sensors in a given fixture (e.g., the “primary fixture”) (e.g., in FIG. 15A, occupant 388 is underneath and/or adjacent to fixture D, which can be the primary fixture). A second level perimeter can be defined (e.g., by the processor) as those fixtures located in closest proximity to the primary fixture (e.g., those surrounding the primary fixture, for example, fixture C in FIG. 15A, and a fixture to the right of fixture D, if present), and the primary fixture can identify and communicate this information to fixtures in the second level perimeter (e.g., via processor 336 and communications device 344 and/or processors and/or controllers that may be external to the fixture(s)). A third level perimeter can be defined as those fixtures surrounding the fixtures defining the second level perimeter (e.g., fixture B, and a fixture two fixtures to the right of fixture D, if present), and so on (e.g., a fourth, fifth, sixth, and higher order proximity perimeter can be defined similarly). At a determined point, fixtures in a perimeter (e.g., a fourth or higher perimeter) can be considered unoccupied, and light levels can be adjusted accordingly (e.g., less light may be required for unoccupied areas). Through at least the use of such proximity perimeters, efficient lighting can be achieved, for example, the primary fixture (e.g., fixture D) can be set at a higher output than fixtures in the second level perimeter (e.g., fixture C), fixtures in the second level perimeter (e.g., fixture C) can be set at a higher output than fixtures in the third level perimeter (e.g., fixture B), and so on (e.g., to form “light rings”).

Environmental sensors 352 can include temperature sensors, humidity sensors, pressure sensors and/or the like (e.g., and may form part of a “HVAC kit” for and/or included with some of the present fixtures). Environmental characteristics captured by such sensors be used to communicate HVAC demands and/or faults (e.g., room temperature and/or humidity is too low and/or too high) to HVAC system(s) and/or HVAC personnel, which may further decrease power consumption and/or speed repairs to defective components. Environmental sensors, as with all sensors of the present fixtures, can be used in conjunction with other sensors. For example, environmental sensors 352 and light harvesting sensors 350 can provide environmental characteristic data to processor 336, which can then use the data to optimize lighting and HVAC to minimize energy consumption. For example, peripherals 368, such as window and/or skylight binds and/or shades (which may be controllable through wireless switches) can be actuated to minimize heat gain (e.g., as indicated by environmental sensors 350) while balancing natural day lighting (e.g., as indicated by light harvesting sensors 348). Through such features, cost savings can be optimized (e.g., through minimization of power requirements). In embodiments without sensors, similar functionality can be preprogrammed (e.g., optimal lighting and/or peripheral actuation) and stored into memory 338.

Safety sensors 356 can comprise a variety of sensors (e.g., and may form a part of a “safety kit” for and/or included with some of the present fixtures). For example, accelerometers and/or gyroscopes can detect excessive seismic or other movement to identify emergency situations. Similarly, laser distance sensors can detect the distance to a ceiling, floor, and/or wall of an environment in order to determine if a ceiling or structure collapse has occurred and/or is impending. Other traditional sensors such as smoke detectors and/or carbon monoxide detectors can also be used to detect smoke and/or other signs of fire and/or carbon monoxide levels. In the event of a detected emergency, processor 336 can use communications device 344 to notify first responders, and/or control light output to indicate an emergency situation (e.g., by flashing or strobing lights and/or illuminating a pathway to a nearest exit). FIG. 16 provides an example of such operation. As shown, during an emergency, the present light fixtures can cooperate to enhance egress and/or otherwise ensure the safety of occupants. For example, fixtures 400 near the perimeter of an area can strobe, emit red light, and/or perform any other function suitable for alerting occupants to the occurrence of an emergency. Fixtures in the interior (e.g., 404) can indicate the direction of the nearest exit (e.g., by strobing and/or flashing LEDs sequentially to indicate a direction, as shown by the arrows in FIG. 16). Fixtures directly adjacent an exit (e.g., of a given room and/or of the building), such as fixture 408, can emit green light to indicate an exit is safe. Through use of other sensors (e.g., environmental sensors 352, such as temperature sensors, smoke detectors, seismic sensors, and/or the like) fixtures can detect if an area is safe (e.g., to exit). For example if fixture 412 detects a high temperature (e.g., indicative of fire), fixture 412 can emit orange and/or red light to indicate that the exit and/or area may not be safe.

In some embodiments, such sensors may be configured to provide for other desirable functionality. For example, some embodiments of the present fixtures (e.g., 34) may be configured to provide an image, map, floor plan, and/or the like of at least a portion of a building or space within which the fixture is installed. For example, in some embodiments, an optical sensor, such as a camera, of a fixture (e.g., 34) may capture an image (or other spatial representation) of an environment near or surrounding the fixture. In such embodiments, a processor (e.g., 336 or a separate processor such as may be disposed in a local or remote server) may be configured to combine or stitch the captured image with image(s) captured by optical sensor(s) of other fixture(s) (e.g., to provide for an image, map, floor plan, and/or the like of a larger portion of the building or space). In some embodiments, a processor (e.g., 336) may analyze an image of an environment provided by optical sensor(s) of light fixture(s) (e.g., 34) to determine dimensions associated with the environment. For example, in some embodiments, a processor (e.g., 366) may be configured to identify structure(s) within the image of known dimensions, such as doors, doorways, windows, furniture, and/or the like, and use the identified structure(s) to determine a scale (e.g., pixels per foot, which may vary across the image) associated with the image, and use the scale to determine the dimensions of other structure(s) (e.g., such as walls, floors, and/or the like) within the image.

The present fixtures can also include different and/or additional devices. Speakers can be included (e.g., to communicate with individuals in the area, for example, during an emergency, or to play music). For another example, a combination of speakers and microphones can also be used to implement a public address (PA) system and/or to enhance security (e.g., through audio capture devices, such as microphones, alone or in combination with cameras, as described above, which may form part of a second level “Security Kit” for and/or included with some of the present fixtures). The present fixtures can also comprise indicators (e.g., small additional light sources, such as LEDs), which can be activated by processor 336 to confirm proper functioning of the present fixtures (e.g., connection with a network, receipt of commands, operating mode, such as on or off, and/or the like). The present fixtures may additionally comprise a battery back-up (e.g., which may form part of LED dimming power supply 340, and may have an indicator and a test button), or an inverter (e.g., in the case of a remote back-up battery or batteries) to continuously supply lighting in power-out conditions. The present fixtures may additionally include connector(s), such as USB connectors, proprietary connectors, and/or the like, for attaching additional components, modules, and/or the like (e.g., to expand functionality of the fixtures).

Some embodiments of the present fixtures are configured to operate in an autonomous fashion (e.g., with self-contained and integrated intelligence and communication systems, as described above). Multiple fixtures can be configured to communicate wirelessly in order to work together, using pre-set logic 374 (e.g., programmed into memory 338), programmable logic 374 (e.g., by a user and/or a technician, such that the logic is adjustable), and/or the like. As those of ordinary skill in the art will appreciate, control of the present fixture(s) and/or appropriate fixture logic can be accomplished in a variety of ways, including, but not limited to, calendar events (e.g., date and/or time), timers (e.g., conventional timers), sensor data (e.g., as described above), manual switches, pre-set logic, programmable logic, proprietary software controls (e.g., which, in some embodiments, forms a part of the present fixtures), third party software controls, demand response signals (e.g., from power and/or utility companies), and/or the like. By way of example, and not by way of limitation, pre-set logic (e.g., code compliance task-lighting configurations) can be programmed (e.g., stored into a memory 338) into the present fixtures and/or the present fixtures can be configured to (e.g., through wired and/or wireless communication with other fixtures and/or control components) to provide illumination (e.g., at code required performance levels) for, for example, specific occupancy characteristics and/or task lighting. For example, such spaces and tasks (e.g., that can have corresponding pre-set logic) can include, but are not limited to, open office, private office, public area (e.g., lobby, reception area, elevator lobby, and/or the like), conference room, meeting room, training room, cafeteria, lunch and/or break room, restroom, storage area (e.g., warehouse), library, utility room (e.g., information-technology room, HVAC equipment room, and/or the like), corridor (e.g., hallways, entrance and/or exit corridor, and/or the like), stairwells (e.g., exit stairwells), manufacturing room (e.g., shop, lab, assembly room, equipment room, inspection room, and/or the like), shipping and/or receiving area, parking garage, and/or the like, and/or custom areas and/or tasks. For example, some control variables can include high end trim, low end trim, fixture output (e.g., in lumens), color temperature (in Kelvins), fixture on, fixture off, dimming variables (e.g., ramp up, ramp down, ramp to off, and/or the like), ambient lighting variables (e.g., action required, stable, more light detected, less light detected, and/or the like), occupancy variables (e.g., initial occupancy detected, occupancy detected, no occupancy detected after a certain period of time, and/or the like), tuning (e.g., user controlled and/or automatic lumen maintenance as the light source degrades over time, for example, an under driving value for powering a newer light and an over driving value for powering an older light, and/or the like), proximity recognition (e.g., to objects, windows, skylights, and/or the like), strobe/flash sequences, power outlet control, electric window control (e.g., shades, blinds, and/or the like), master/slave settings, emergency lighting (e.g., emergency exit lighting), security lighting (e.g., night lights, occupant exiting assistance, and/or the like), and/or the like.

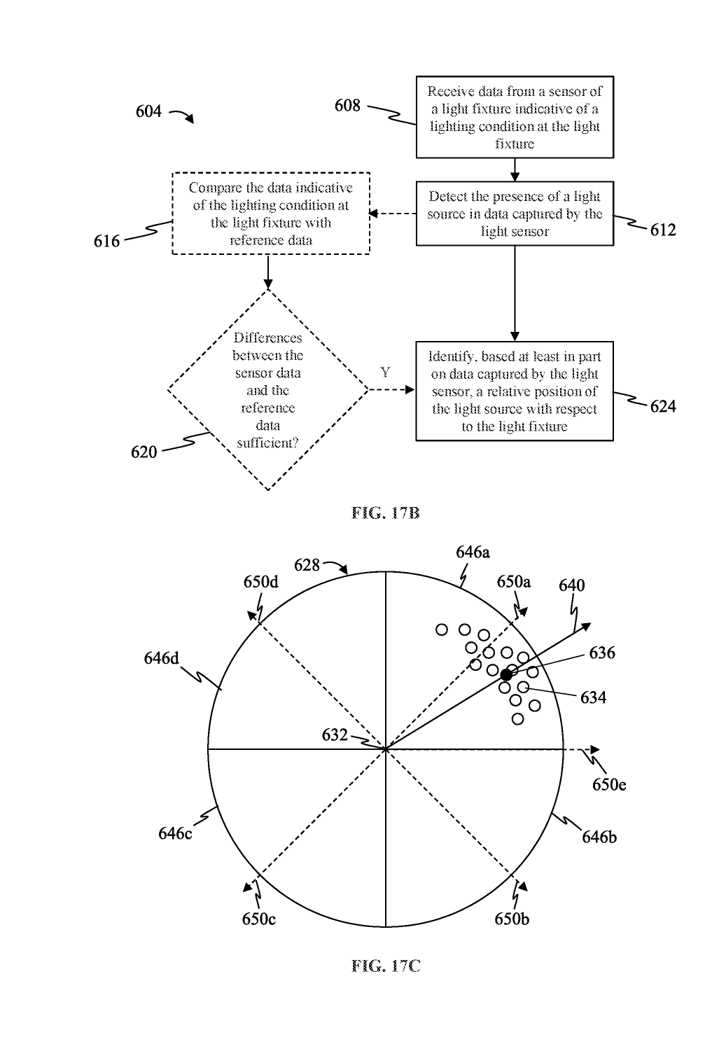

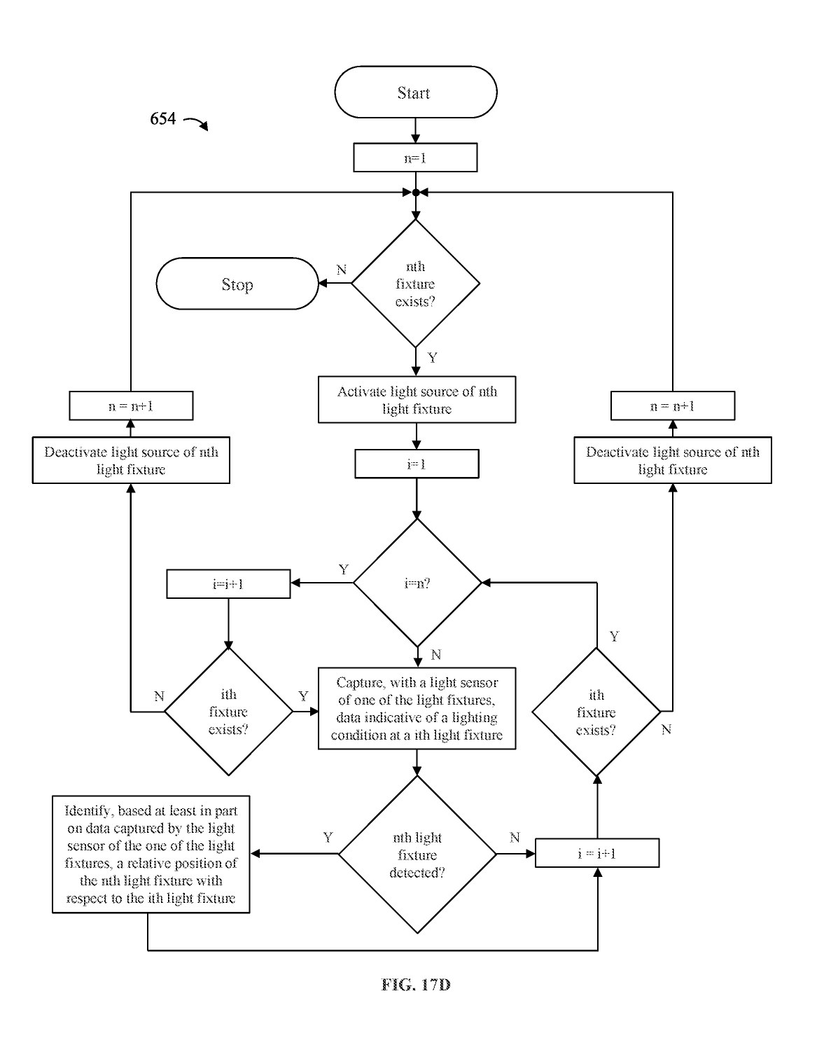

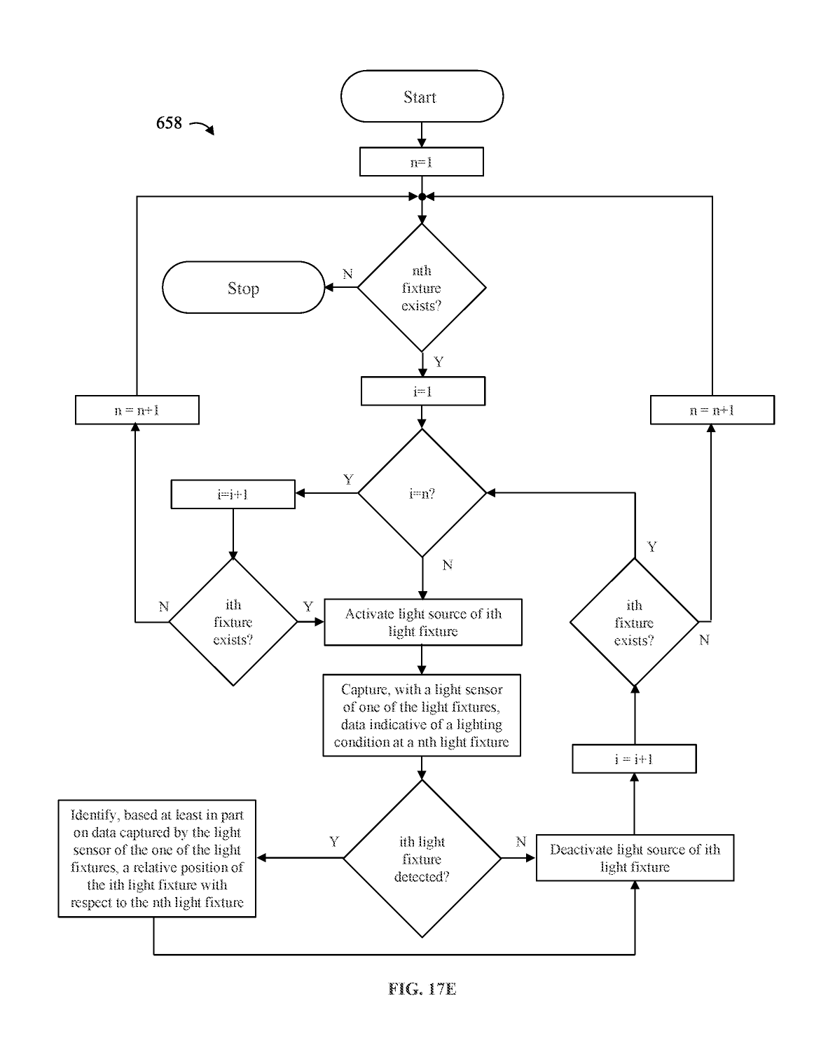

In the embodiment shown, fixture 34 is configured to facilitate the determination of the physical position(s) (e.g., relative position(s)) of objects, such as peripherals and/or other light fixture(s), once the fixture and other light fixture(s) are installed within a building or space. For example, and referring now to FIG. 17A, shown is one embodiment 600 of the present systems, which may be suitable for use with some embodiments of the present fixtures (e.g., 34). In the embodiment shown, system 600 comprises a plurality of light fixtures 34, each having a light sensor configured to capture data indicative of a lighting condition. For example, in this embodiment, a light sensor of a light fixture (e.g., or each light fixture) is configured to capture data indicative of at least one of light intensity and light direction. Such light sensors can comprise any suitable light sensor, such as, for example, a lux meter, camera, and/or the like, and may include other components, such as, for example, a light pipe.

In the depicted embodiment, for a given fixture 34, the presence of a light source in data captured by a light sensor of the fixture may be detected by a processor (e.g., a processor 336 of the light fixture, a processor of another one of the light fixtures, a processor remote from the light fixtures (e.g., on a router in communication with the light fixtures), a cloud-based processor, and/or the like), and the processor may be configured to identify, based at least in part on data captured by the light sensor, a relative position (e.g., relative direction and/or distance) of the light source emitted by the object(s) with respect to the light fixture.

To illustrate, and referring additionally to FIG. 17B, depicted is a flow diagram of one embodiment 604 of the present methods, which may be implemented by a processor (e.g., such as a processor 336 of a fixture 34) (e.g., as logic 374). In the embodiment shown, at step 608, the processor may receive data from a light sensor of the light fixture indicative of a lighting condition at the light fixture (“sensor data”). In this embodiment, at step 612, the processor may detect a light source, such as a light source of another one of fixtures 34 and/or peripherals 368, in the sensor data. In some embodiments (e.g., 604), step 612 comprises step 616, in which the processor may compare the sensor data with reference data, and step 620, in which the processor may determine if differences between the sensor data and the reference data are sufficient to indicate the presence of a light source (e.g., at least a 5, 10, 15, 20, 25, or greater percent difference in light intensity, luminosity, and/or the like between the sensor data and the reference data, and/or a portion of the sensor data and a corresponding portion of the reference data). Such reference data may include, for example, data indicative of the lighting condition at the fixture, which may be captured by the light sensor of the fixture, when light sources within the vicinity of the fixture (e.g., in the same room as the fixture) are not activated (e.g., when an environment around the fixture is dark).

In this embodiment, at step 624, the processor may determine a relative position of a detected light source with respect to the light fixture. The relative position of a detected light source with respect to a light fixture can be determined in any suitable fashion, and the following examples are provided only by way of illustration. For example, and referring additionally to FIG. 17C, shown is a spatial representation of data 628, which may comprise sensor data, or in some embodiments, may comprise sensor data normalized by reference data (e.g., with the reference data subtracted from the sensor data). In the example shown, data 628 may be associated with an origin 632 that may be fixed relative to the light sensor, and thus, relative to the light fixture.

In this example, to determine a direction of a detected light source relative to the light fixture, a luminosity, intensity, and/or the like of each data point (e.g., or of each data point 634 that has a luminosity, intensity, and/or the like above a threshold, to, for example, reduce processing requirements) may be used to determine intensity-weighted average coordinates 636 for data 628, and a direction 640 between origin 632 and the intensity-weighted average coordinates may be used to indicate the direction of the detected light source relative to the light fixture. Alternatively or additionally, in the example shown, data 628 may be divided into sections (e.g., four sections, 646a-646d, as shown), each associated with a direction (e.g., directions 650a-650d, respectively) relative to the light fixture, and the distribution of data points 634 having a luminosity, intensity, and/or the like that is above a threshold within the sections may be used to determine a relative direction of a detected light source with respect to the fixture. To illustrate, in this example, each of data points 634 lies within section 646a, which is associated with direction 650a, and thus, direction 650a may be indicative of a direction of a detected light source relative to the light fixture. If, in the depicted example, data points 634 were substantially evenly distributed amongst two or more sections (e.g., the two more sections were within 5, 10, 15, 20, 25, or more percent of one another in terms of number of data points 634), such as amongst sections 646a and 646b, a direction defined between the two or more sections, such as direction 650e, may be indicative of a direction of a detected light source relative to the light fixture.

In this example, a relative distance of a detected light source with respect to the light fixture may be determined by an average luminosity, intensity, and/or the like of each data point in data 628 (e.g., or of each data point 634 that has a luminosity, intensity, and/or the like above a threshold) (e.g., the average luminosity, intensity, and/or the like of data 628 may decrease in a predictable fashion with distance between the detected light source and the light fixture). In this manner, the relative position of a plurality of light fixtures may be determined by successively turning on and off each respective light fixture in an environment and determining the relative distance between the respective light fixture and the light fixture having the light sensor. In some embodiments, the relative position of a peripheral 368, such as a laser pointer, may be determined by pointing the laser pointer at the light sensor and measuring the luminosity, intensity, and/or the like, emitted from the laser pointer.

In addition or as an alternative, relative distances may be determined relatively. For example, if it is determined that a first light fixture and a second light fixture are spaced from a third light fixture in roughly the same direction, then the intensity of light from the first fixture, as detected at the third fixture, can be compared to the intensity of light from the second fixture, as detected at the third fixture, and the one of the first and second light fixtures with the highest intensity measured at the third light fixture will typically be closer to the third light fixture than the one with the lower intensity.

In these ways and others, each of fixtures 34 may be able to determine a relative position of at least one other of the fixtures relative to the fixture, thus facilitating the determination of the physical positions of the fixtures once the fixtures are installed within a building or space (e.g., sometimes referred to as “fixture mapping”). For example, in the embodiment shown, a processor (as described above) is configured to activate a light source of a first one of the light fixtures (e.g., 34a) (e.g., a list of light fixtures may be obtained, for example, by querying a network to which the light fixtures are connected), and capture, with a light sensor of one of the light fixtures, data indicative of a lighting condition at a second one of the light fixtures (e.g., 34b). In this embodiment, sensor data may be captured by a light sensor of the second light fixture, and/or may be captured by a light sensor of each of one or all other of the light fixtures (e.g., 34d), and particularly if the relative position of the other light fixture with respect to the second light fixture has been determined or is otherwise known (e.g., the relative position of the other light fixture with respect to the second light fixture may be used to transform sensor data obtained by a sensor of the other light fixture from a reference frame associated with the other light fixture into a reference frame associated with the second light fixture). In a same or similar fashion as to described above, in the depicted embodiment, the processor may be configured to identify, based at least in part on the sensor data, a relative position of the first light fixture with respect to the second light fixture. Also in a same or similar fashion as to described above, in the embodiment shown, the processor may be configured to compare sensor data with reference data (e.g., configured to compare the data indicative of the lighting condition at the second light fixture while the first light fixture is activated to data indicative of the lighting condition at the second light fixture while the first light fixture is not activated), and, in some embodiments, may be configured to identify the relative position of the first light fixture with respect to the second light fixture if differences between the sensor data and the reference data are sufficient (e.g., exceed a predetermined threshold).

In this embodiment, the processor may be configured to repeat a same or a similar process for others of light fixtures 34 (e.g., up to and including until the relative position of each fixture with respect to each other fixture has been determined). For example, in the depicted embodiment, the processor is configured to capture, with the light sensor of one of fixtures 34, data indicative of a lighting condition of at a third one of the light fixtures (e.g., 34c), and identify, based at least in part on the sensor data, a relative position of the first light fixture with respect to the third light fixture (e.g., and continue to attempt to identify the relative position of the activated first light fixture with respect to each other light fixture before deactivating the first light fixture and repeating the process with another one of the light fixtures activated, as shown for method 654 of FIG. 17D). Alternatively or additionally, the processor may be configured to deactivate the light source of the first light fixture, activate the light source of the third light fixture, and capture with the light sensor of one of fixtures 34, data indicative of a lighting condition at the second light fixture, and identify, based at least in part on the sensor data, a relative position of the third light fixture with respect to the second light fixture (e.g., and continue to attempt to identify the relative position of the second light fixture with respect to each other light fixture by individually activating the other light fixture and repeating the process for each other light fixture, as shown for method 658 of FIG. 17E). Of course, in other embodiments, any suitable combination of methods 654 and 658 may be used to perform fixture mapping functionality.

In some embodiments, such fixture mapping may facilitate the identification of other structure(s) within an environment near or surrounding fixtures 34. For example, in the embodiment shown, if a sensor of fixture 34a is unable to detect a light source of fixture 34e when fixture 34e is activated, or if a sensor of fixture 34e is unable to detect a light source of fixture 34a when fixture 34a is activated, but fixture 34e is known to be adjacent to fixture 34a (e.g., via one or more of the processes described above), the presence of a wall or other obstruction between fixture 34a and 34e may be indicated.

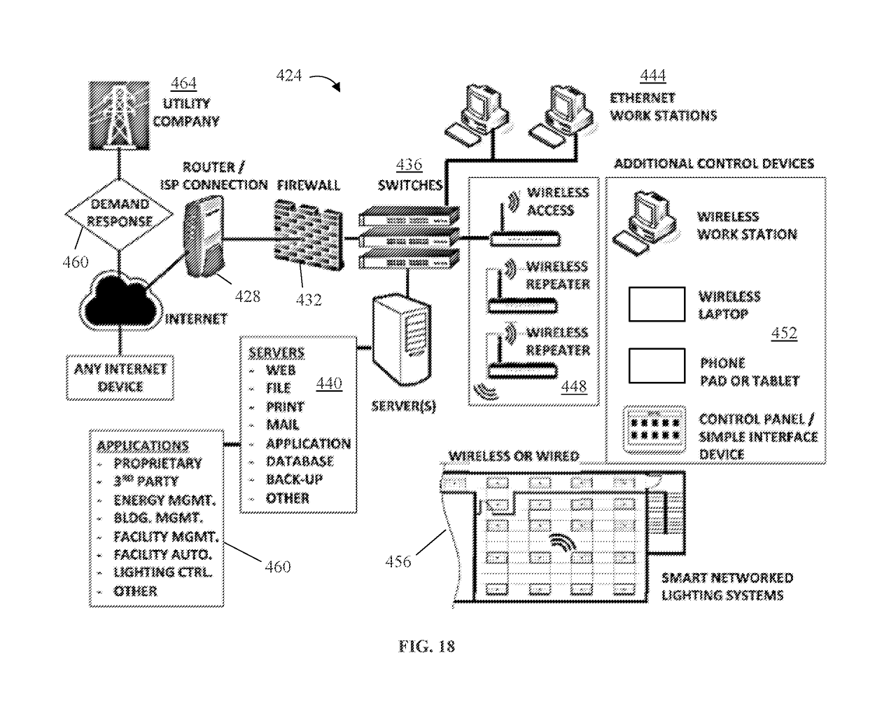

FIG. 18 depicts an example of a network environment suitable for use with some embodiments of the present fixtures (e.g., 34). Network 424 is traditional in that it comprises an ISP connection 428, a firewall 432, various switches 436 (e.g., for wired network connection to servers 440 and Ethernet work stations 444), as well as wireless network hardware 448 for broadcasting a Wi-Fi network (e.g., to connect wireless devices 452). As shown, embodiments of the present fixtures (e.g., or a group 456 of the present fixtures, also known as a “smart networked lighting system”) can be configured to communicate over a Wi-Fi network can be configured to communicate wirelessly (e.g., comprising a Wi-Fi communication device 344) and/or through a wired connection (e.g., comprising an Ethernet communication device 344). Control software for group 456 can be embedded on a fixture (e.g., a “master” fixture), and/or be run by a server 440 as an application (e.g., remote to the fixture(s)). Through such connectivity, the group of lights is able to respond to various conditions (as described above) (e.g., in the example shown, to generate a unified response to a demand response 460 from a utility company 464).

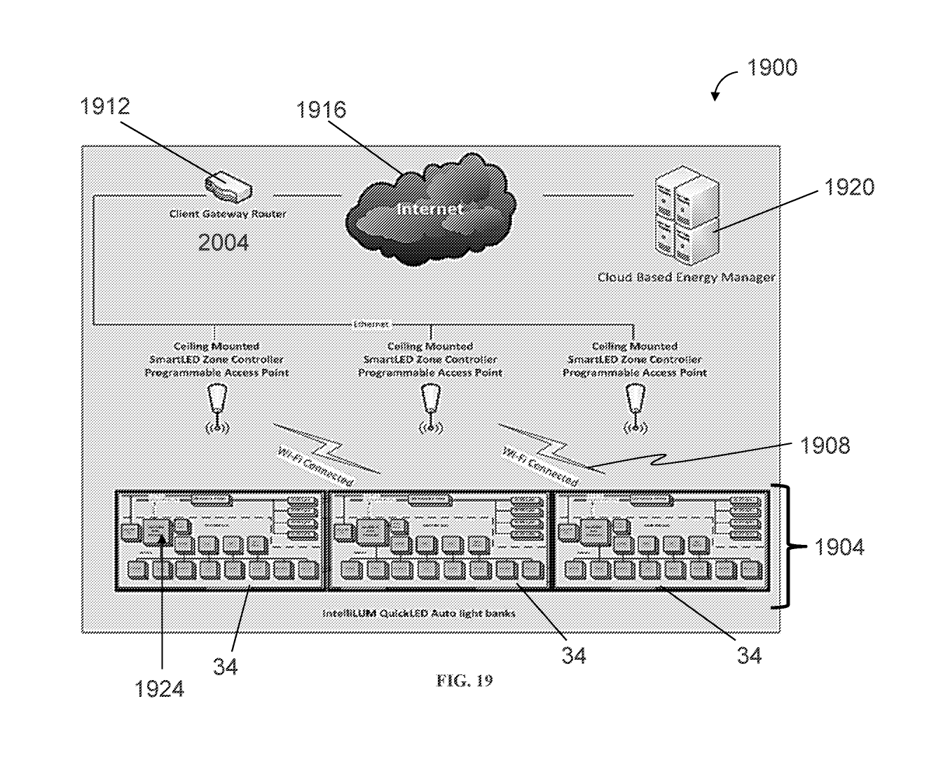

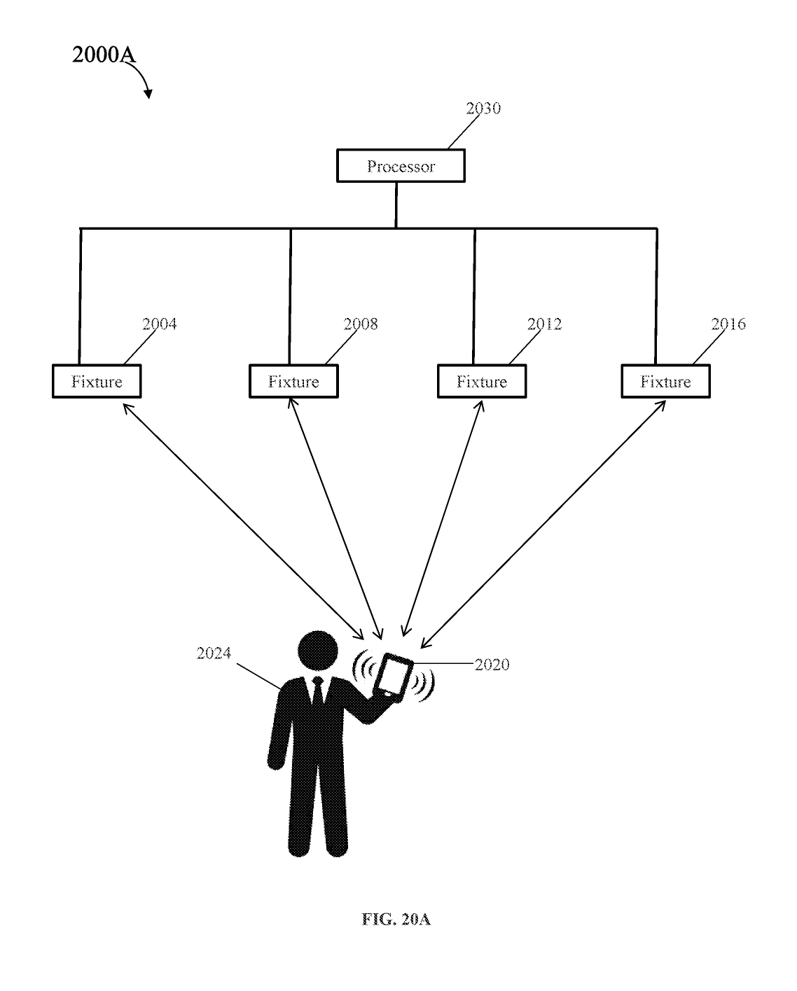

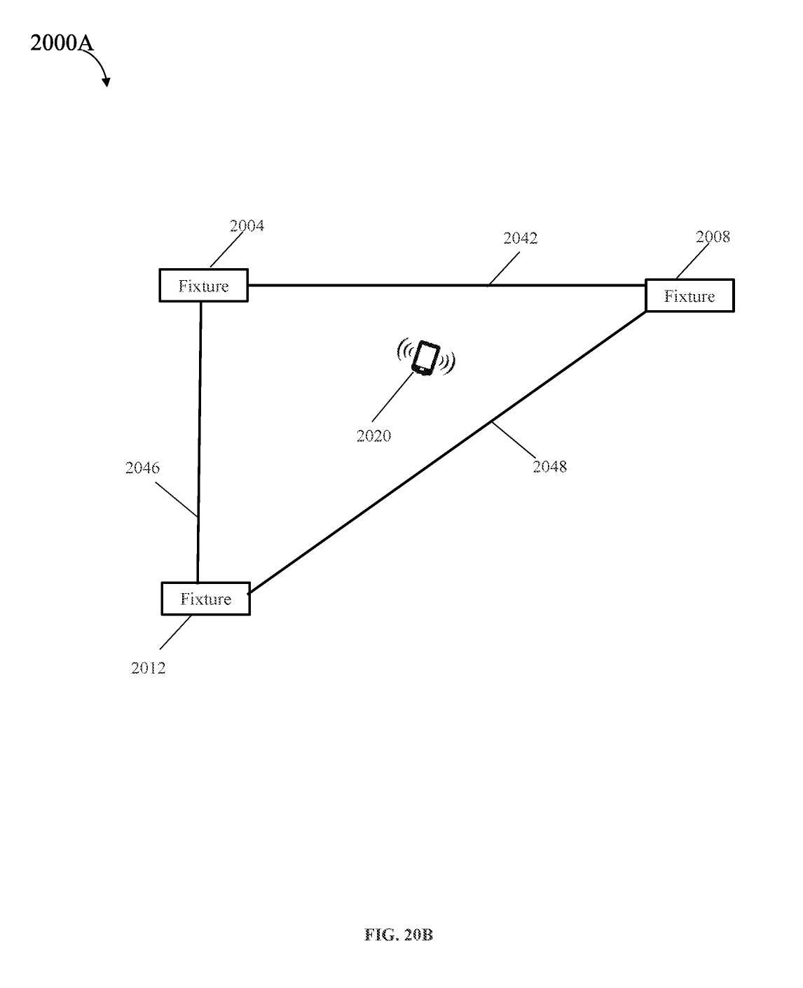

Referring now to FIG. 19, shown is one embodiment of the present systems, which may be suitable for use with some embodiments of the present fixtures (e.g., 34). In the embodiment shown, system 1900 comprises a plurality of lighting components 1904, each connectable to a wireless first network 1908. Lighting components 1904 can include any suitable lighting component, such as, for example, one or more light fixtures (e.g., 34), light switches, lux meters, light pipes, cameras, other sensors, and/or the like.

For example, in this embodiment, lighting components 1904 includes a plurality of light fixtures 34. In the depicted embodiment, each of light fixtures 34 includes a wireless communications device 344 configured to communicate over wireless first network 1908. For example, in the embodiment shown, a communications device 344 of each fixture 34 is configured to receive a command indicative of a desired lighting condition via wireless first network 1908, and a processor 336 of the fixture is configured to control, based at least in part on the received command, a light source of the light fixture (e.g., or two or more of the light fixture(s), for example, via communications between communications devices 344). Of course, as described above, each of light fixtures 34 may include one or more sensors, each configured to capture data indicative of an environmental condition, and a processor 336 of the fixture may be configured to control, based at least in part on the data captured by the one or more sensors, a light source of the light fixture (e.g., or two or more of the light fixture(s), via communications between communications devices 344).

In this embodiment, system 1900 includes a wireless network controller 2012 configured to control access to and/or communications through wireless first network 1908. For example, in the depicted embodiment, wireless network controller 1912 may comprise a virtual private network (VPN) gateway router. While, in the embodiment shown, wireless network controller 1912 is a separate component from lighting components 2004, in some embodiments, a wireless network controller (e.g., 1912) may be a component of a lighting component 2004 (e.g., such as a communications device 344 of a fixture 34).

In this embodiment, wireless network controller 1912 is configured to prevent (e.g., unauthorized) personal user devices (e.g., cellular phones, tablets, personal computers, laptops, and/or the like), and more generally, unauthorized devices, from directly communicating over wireless first network 1908 (e.g., to prevent unauthorized control over lighting components 1904). Instead, in the depicted embodiment, wireless network controller 1912 may be configured to receive a command indicative of a desired lighting condition from a personal user device, and to transmit a second command indicative of the desired lighting condition to one or more of lighting components 1904 over wireless first network 1908. For example, in the embodiment shown, wireless network controller 1912 may be configured to receive a command from a personal user device over a second network 1916 (e.g., the Internet, in this embodiment). In some embodiments, second network 1916 may include a subnetwork of a network in which wireless first network 2008 is also a subnetwork, a subnetwork of the wireless first network, and/or the like.

In the depicted embodiment, system 1900 comprises a server 1920 connectable to second network 1916 and configured to receive a command indicative of a desired lighting condition from a personal user device over the second network. For example, in the embodiment shown, server 1920 may be configured to provide a web-based user interface for receiving a command from a personal user device. In this embodiment, server 1920 is configured to transmit a second command indicative of the desired lighting condition to one or more of lighting components 1904 over the wireless first network 1908 (e.g., through wireless network controller 1912).

In this embodiment, wireless first network 1908 is encrypted, and each of lighting components 1904 includes a memory (e.g., 338) storing a private key for communicating over the wireless first network (e.g., which may be assigned to the lighting component by the manufacturer of the lighting component, generated during initialization of the lighting component, and/or the like). In the depicted embodiment, each of lighting components 1904 may be assigned a certificate that may be verified upon initialization (e.g., by wireless network controller 1912, by server 1920, and/or the like) before the lighting component is permitted to communicate over and/or connect to wireless first network 1908. In the embodiment shown, one or more of lighting components 1904 (e.g., each of the lighting components) is configured to communicate over wireless first network 1908 using a secured CoAP communications protocol. In these ways and others, lighting components 1904 may be able to securely communicate over wireless first network 1908, and unauthorized devices (e.g., without an operable private key, without an operable certificate, and/or the like) may be hindered or prohibited from communicating over and/or connecting to the wireless first network.

In some embodiments, system 1900 includes a plurality of security layers configured to protect wireless first network 1908 from malicious attack. Each of the plurality of security layers may include any suitable means configured to protect wireless first network 1908 from malicious attack. For example, each of the plurality of security layers may include any one or combination of the following: (1) fixtures 34 with embedded public and private keys used for use over the customer's sites; (2) operation of all network communication using the Internet Engineering Task Force (IETF) developed Constrained Application Protocol (CoAP), specifically developed for Machine to Machine (M2M), and encrypted using Datagram Transport Layer Security (DTLS) encryption; (3) a registration server that validates devices entering wireless first network 1908 based on credentials and allocates keys only after verification; (4) encrypting all wireless traffic with a rotating key over the 802.11 WPA/PSK2 protocol (e.g., 63 character AES randomly generated rotating key); and (5) VPN links to secure cloud servers that use Internet Protocol Security (IPSec) Tunnels that are encrypted with 256-bit AES.

Referring now to FIG. 20A, an embodiment of a system 2000 comprising a plurality of fixtures (e.g., 2004, 2008, 2012, 2016) is shown. Fixtures (e.g., 2004, 2008, 2012, 2016) each may be substantially similar to fixture 34 described above. For example, each of the fixtures (e.g., 2004, 2008, 2012, 2016) may comprise an occupancy sensor 348 and/or a communication device 344 as described above. The plurality of fixtures may be installed, for example, on the ceiling of a structure (e.g., room, hallway, lobby, etc.), and the fixtures may be connected to a central processor 2030. Each of the plurality of fixtures (e.g., 2004, 2008, 2012, 2016) may be configured to receive one or more signals from a mobile device 2020 (which may be held by a person 2024 or attached to another object in the structure) and communicate the received signals to processor 2030. Mobile device 2020 may be a mobile phone, a gaming device, a tablet computer, music playing device, an Internet of Things (JOT) device (e.g., a Bluetooth tag and/or other IoT devices), or any other mobile device that is capable of transmitting and/or receiving a wireless signal. The signals received by the plurality of fixtures may be an audio signal, a WiFi signal, a Bluetooth signal, a visible light signal, or an invisible light signal (e.g., infrared light), or any combination thereof.

Because the distance from mobile device 2020 to fixtures 2004, 2008, 2012, 2016 may vary, the strength of signals received at fixtures 2004, 2008, 2012, 2016 may vary according to the distance variation (generally, the closer a fixture is to mobile device 2020, the stronger the signal is received at the fixture). In the depicted embodiment, processor 2030 may compare the strength of signals received from fixtures 2004, 2008, 2012, 2016 and estimate a location of object 2020 relative to fixtures 2004, 2008, 2012, 2016. For example, if fixtures 2004, 2008, 2012, 2016 are each installed on one of the four corners of a ceiling of a room, and processor 2030 determines that signals received from 2004, 2008, 2012 are the three strongest of the four received signals, processor 2030 may then determine that object 2020 is located in the triangle area bounded by fixtures 2004, 2008, 2012 (i.e., on the floor below these three fixtures), as illustrated in FIG. 20B.

Further, processor 2030 may also compare the strength of signals received at these three fixtures and determine an approximate location of mobile device 2020 in the triangle shown in FIG. 20B. For example, if the strength of the signals received at fixtures 2004 and 2008 are approximately equal, processor 2030 can determine that mobile device 2020 is located at a point that is the same distance from each of fixture 2004 and fixture 2008. Further, if the strength of the signal received at fixture 2004 is twice as strong as the signal received at fixture 2012, processor 2030 can determine that mobile device 2020 is twice as far from fixture 2012 as it is from fixture 2004. Thus, processor 2030 can then determine that mobile device 2020 is located at a point that satisfies each of these conditions on the position relative to the three fixtures. With this method, the accuracy of mobile device 2020's estimated location can be increased by referencing additional fixtures and/or fixtures that are closer together or whose positions are otherwise known with greater precision.

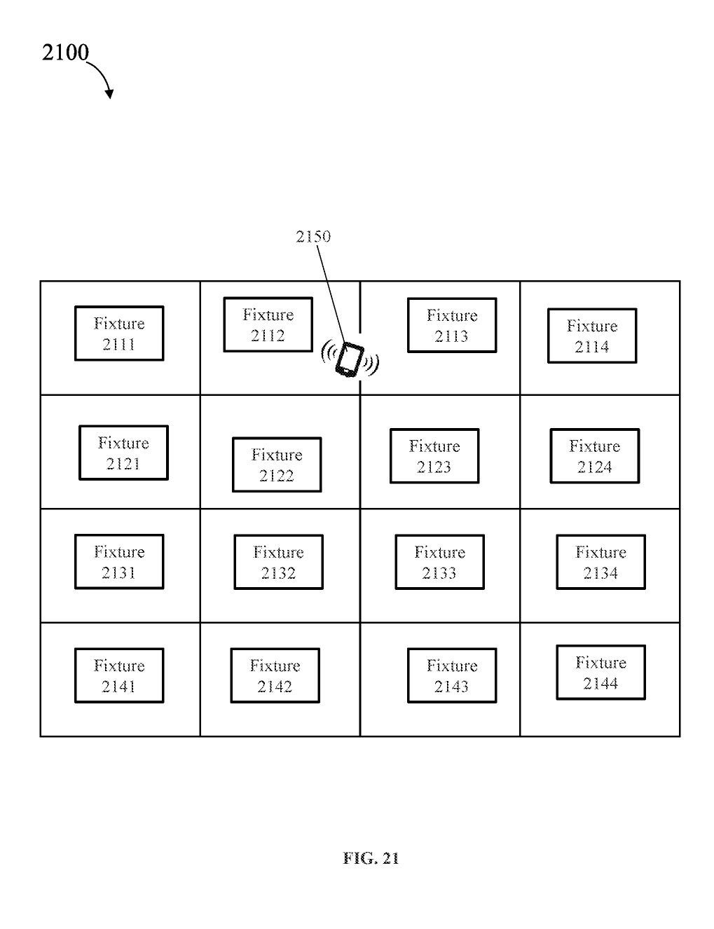

FIG. 21 depicted an embodiment of deployment pattern for fixtures. In the depicted embodiment, 16 fixtures are deployed on an equally distributed grid, and all fixtures are connected to a central processor (e.g., 2030). If the fixtures are installed on the ceiling of a structure (e.g., room, hallway, lobby, etc.), this fixture distribution grid can be mapped to the floor and location of a mobile device can be determined on the floor. For example, in the depicted embodiment, the central processor compares signals from all 16 fixtures received from mobile device 2150 and determines that signals from fixtures 2112, 2113, 2122 are the three strongest signals, it can be determined that mobile device 2150 is located within a triangular area formed by fixtures 2112, 2113, 2122 that is projected onto the floor. The approximate location of mobile device 2150 in the triangular area can then be further estimated based on the process described above in connection with FIG. 20B. In the depicted embodiment, fixtures may be configured to receive signals from mobile device 2150 at different time periods and the processor may be configured to determine location of mobile device 2150 at different time periods using the above described process and track the movement of mobile device 2150. In some embodiments, fixtures may be distributed according to a regular (e.g., rectangular grid) pattern, an irregular pattern (e.g., in which fixtures are unevenly distributed, such as a non-rectangular grid, or the like).

In some embodiments, each of the plurality of fixtures (e.g., 2004, 2008, 2012, 2016) may be assigned a coordinate or set of coordinates, and/or each fixture may be programmed with or otherwise store in memory an indication of its own location relative to one or more other fixtures. For example, when the plurality of fixtures are installed on the ceiling of a structure, fixture 2004 may be assigned a baseline or reference set of coordinates (e.g., of 0, 0, 0) and coordinates of other fixtures may be determined relative to the baseline or reference coordinates. In some embodiments, the distance from the floor to the ceiling can also be measured and reflected into the coordination system. In some embodiments, one or more of the plurality of light fixtures may be configured to have a GPS device (e.g., chip and antenna) that allows the location of the fixture to be precisely determined. Based on the measured location of the fixtures using GPS, their coordinates can then be determined in the assigned coordination system (e.g., a coordination system with fixture 2004 assigned with the baseline or reference coordinates (e.g., 0, 0, 0)).

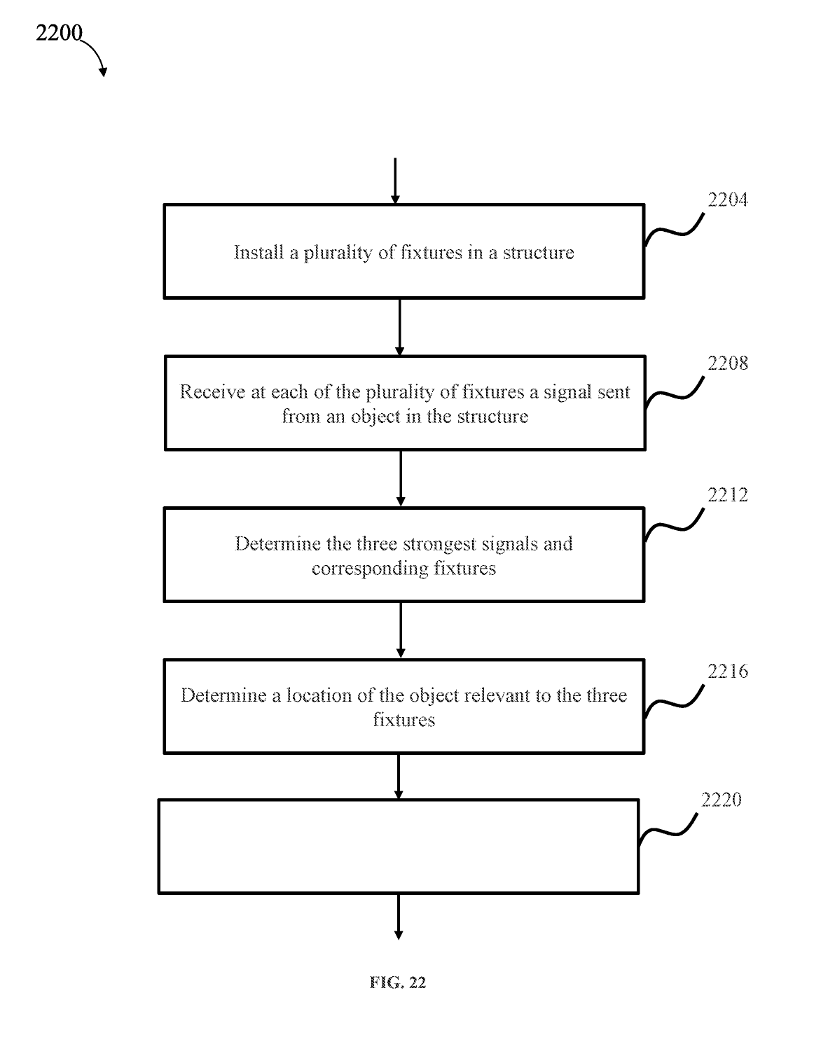

FIG. 22 illustrates one embodiment of a method 2200 for determining a location of an object using a plurality of fixtures. In the depicted embodiment, at step 2204, a plurality of fixtures are installed in a structure. The structure may be a room, lobby, hallway, etc. The plurality of fixtures may be installed, e.g., on the ceiling of the structure. At step 2208, each of the plurality fixtures receives a signal from the same object (the signals may be sent or reflected by the object) in the structure. The object may be a mobile device such as a mobile phone, a gaming device, a tablet computer, music playing device, an Internet of Things (JOT) device (e.g., a Bluetooth tag and/or other IoT devices), or any other mobile device that is capable of transmitting and/or receiving a wireless signal. The mobile device may be carried by a person. At step 2212, a processor receives the signals from the plurality of fixtures, and determines the three signals with strongest strengths and the corresponding fixture that received the signals. At step 2216, a processor determines a location of the object relative to the three fixtures corresponding to the three strongest signals. In some embodiments, method 2200 may further comprise further steps illustrated in step 2220. For example, the determined relative location of the object may be projected to the floor of the structure; the steps 2208-2216 may be repeated at different times to determine the relative locations of the object at various times thus tracking the movement of the object, etc.

For additional description of some embodiments of the present kits, fixtures, systems, and/or the like, see International Application No. PCT/US2014/037651, filed on May 12, 2014 and entitled “RETROFIT AND NEW LIGHT-EMITTING DIODE (LED) LIGHT FIXTURES FOR REPLACEMENT OF A FLUORESCENT LIGHT FIXTURE,” which is expressly incorporated by reference in its entirety.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A system comprising:
a light fixture having a sensor configured to capture data indicative of an atmospheric condition; and
a processor configured to:
detect the presence of an object in data captured by the light sensor; and
identify, based at least in part on data captured by the sensor, a relative position of the object with respect to the light fixture.

2. The system of claim 1, wherein the processor is coupled to a frame of the light fixture.

3. The system of claim 2 wherein the sensor is an acoustic sensor.

4. The system of claim 3, wherein the acoustic sensor includes a microphone.

5. The system of claim 1 wherein the sensor is a light sensor.

6. The system of claim 5, wherein the light sensor comprises a light pipe.

7. The system of claim 1 wherein the sensor is configured to capture data indicative of at least one of light intensity or light direction.

8. The system of claim 5, wherein the light sensor comprises a camera.

9. A system comprising:
a plurality of light fixtures, each having:
a light source; and
a light sensor configured to capture data indicative of a lighting condition; and
a processor configured to:
activate the light source of a first one of the light fixtures;
capture, with the light sensor of at least a second one of the light fixtures, data indicative of a lighting condition at the second one of the light fixtures; and
identify, based at least in part on data captured by the light sensor of the second one of the light fixtures, a relative position of the first light fixture with respect to the second light fixture.

10. The system of claim 9, wherein the processor is configured to compare the data indicative of the lighting condition at the second light fixture while the first light fixture is activated to data indicative of a lighting condition at the second light fixture while the first light fixture is not activated.

11. The system of claim 10, wherein the processor is configured to identify the relative position of the first light fixture with respect to the second light fixture based on differences between the data indicative of the lighting condition at the second light fixture while the first light fixture is activated and the data indicative of the lighting condition at the second light fixture while the first light fixture is not activated, if such differences exceed a predetermined threshold.

12. The system of claim 9, wherein the processor is configured to:
capture, with the light sensor of a plurality of other ones of the light fixtures, data indicative of a lighting condition at the other ones of the light fixtures; and
identify, based at least in part on data captured by the light sensors of the other ones of the light fixtures, a relative position of the first light fixture with respect to each of the other light fixtures.

13. The system of claim 12, wherein the processor is configured to, for each of the other ones of the light fixtures, compare the data indicative of the lighting condition at the other light fixture while the first light fixture is activated to data indicative of a lighting condition at the other light fixture while the first light fixture is not activated.

14. The system of claim 13, wherein the processor is configured to, for each of the other ones of the light fixtures, identify the relative position of the first light fixture with respect to the other light fixture based on differences between the data indicative of the lighting condition at the other light fixture while the first light fixture is activated and the data indicative of the lighting condition at the other light fixture while the first light fixture is not activated, if such differences exceed a predetermined threshold.

15. The system of claim 9, wherein the light sensor of the one of the light fixtures comprises the light sensor of the second light fixture.

16. The system of claim 9, wherein the processor is configured to:
capture, with the light sensor of a third one of the light fixtures, data indicative of a lighting condition at the third light fixture; and
identify, based at least in part on data captured by the light sensor of the third light fixture, a relative position of the first light fixture with respect to the third light fixture.

17. The system of claim 9, wherein the processor is configured to:
activate the light source of a third light fixture;
capture, with the light sensor of one of the first and second light fixtures, data indicative of a lighting condition at the one of the first and second light fixtures; and
identify, based at least in part on data captured by the light sensor of the one of the first and second light fixtures, a relative position of the third light fixture with respect to the one of the first and second light fixtures.

18. The system of claim 9, wherein the processor is coupled to a frame of at least one of the light fixtures.

19. The system of claim 9, wherein the light sensor of at least one of the light fixtures comprises a light pipe.

20. The system of claim 9, wherein the light sensor of at least one of the light fixtures is configured to capture data indicative of at least one of light intensity and light direction.

21. The system of claim 9, wherein the light sensor of the at least one of the light fixtures comprises a camera.

22.-96. (canceled)
